(19) United States
(12) Patent Application Publication
(10) Pub. No.: US 2003/0216995 A1
(43) Pub. Date: Nov. 20, 2003

(54) Automated financial system and method

(76) Inventors: Thomas DePauw, Nashville, TN (US); Fred Martin, Hendersonville, TN (US); Jerry Saunders, Franklin, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/429,665

(22) Filed: May 5, 2003

Related U.S. Application Data
(60) Provisional application No. 60/380,756, filed on May 15, 2002.

(51) Int. Cl. G06F 17/60

(52) U.S. Cl. 705/37

(57) ABSTRACT

A computer based system and method a computer program product are used in a financial transaction. A quote and a set of terms are established. The quote includes at least one item included in the transaction. The set of terms includes an amount to be financed. A set of financial documents for the transaction are produced as a function of the quote and the set of transaction terms.

This application claims priority to U.S. Provisional Patent Application Serial No. 60/380,756 filed May 15, 2002.

### TECHNICAL FIELD

The present invention relates generally to financial transactions, and more particularly, to an automated system and method used in financial transactions.

### BACKGROUND

The purchase or lease of items or equipment, such as construction or agricultural equipment, engines, computer or electronic items, consumer items, etc., is a very detailed process involving complicated financing decisions and financial documents. The process involves determining the type of financing available for the customer, as well as geographic factors. Additionally, depending on the type of financing and the geographic location of the customer, the number, type, as well as the terms of, the documents required vary.

In a typical sale or lease, the first step includes a quoting process. The quoting process involves a discussion with the customer including determining the equipment which the customer desires to lease or purchase and type and size of desired payment.

The second step may be a credit process. The credit process involves requesting and receiving the customer credit scoring from a credit bureau. The credit scoring is used to determine the type of financing available to the customer. Other factors may also a be used to determine the type of financing available, such as the customer's payment history on past purchases or leases

Once the financing terms have been arranged, the financing documents must be prepared. As discussed above, the number and type of documents, as well as specific clauses or terms in the financing documents will vary. Factors in determining the type of documents include customer, the lessor, the geographic location, and the type of financing. The lessor is generally a subsidiary of the financing company in a particular country. There may be more than one lessor in each country, based on different factors, e.g., currency of the transaction.

Historically, the quote, credit, and document preparation process have been accomplished manually and are generally independent of one another. Recent efforts have automated portions of these processes using computer software applications. Generally, these software tools are used during the formulation of the original transaction.

Prior systems have attempted to automate one or more of the processes with financing process. For example, U.S. Pat. No. 6,029,149 issued Feb. 22, 2000 to Diana R. Dysktra et al, discloses a credit evaluation and loan processing system. Loan application information is entered into a remote computer. A central processing unit is connected to the remote computer. The central processing unit accesses credit bureau information and performs a credit scoring processing process to approve or deny the loan.

However, during the term of the financial transaction, i.e., the term of the loan or lease, certain conditions may arise in which it may be desirable to alter or modify the terms of the transaction. For example, conditions may arise which restrict the cash flow of the user of the equipment. The restriction on the user's cash flow may impede their ability to make payments on the equipment. Rather than allowing the user to default on the loan or lease, it may be desirable to alter or modify the terms of the transaction. The alteration may include, for example, allowing the user to skip or reduce payments for a predetermined period of time in exchange for lengthening the term of the financing.

Additionally, present automated systems are completely independent of the manufacturing or supply processes. Thus, equipment or an item may be quoted during the quote process with no determination that the equipment or item is available or when it would be available.

The present invention is aimed at one or more of the problems addressed above.

### SUMMARY OF THE INVENTION

In one aspect of the present invention, a method for use in a financial transaction is provided. The method includes the steps of establishing a quote and a set of terms for the transaction. The quote includes at least one item included in the transaction. The set of terms includes an amount to be financed.

In another aspect of the present invention, a method for use in a financial transaction is provided. The method includes the steps of establishing a quote for the transaction. The quote includes at least one item included in the transaction. The method also includes the steps of establishing a set of terms for the transaction, the terms including an amount to be financed, establishing at least one changed parameter after a start date of the transaction, and modifying the terms of the transaction in response to the at least one changed parameter.

In still another aspect of the present invention, a computer based system for use in a financial transaction is provided. The system includes a finance computer application located at a first location and a second computer application coupled to the finance computer application and being located at a second location. The second computer application is adapted to provide access for a user to the finance computer application. The finance computer application is adapted to establish a quote and to establish a set of terms for the transaction as a function of the quote.

In one more aspect of the present invention, a computer program product for use in a financial transaction is provided. The computer program product includes computer readable program code means for establishing a quote for the transaction and computer readable program code means for establishing a set of terms for the transaction.

### BRIEF DESCRIPTION OF THE DRAWINGS

FIG. 1 is a flow diagram of a financial transaction process, according to an embodiment of the present invention;

FIG. 2 is a block diagram of a computer based system for use in a financial transaction, according to an embodiment of the present invention;

FIG. 3 is a first flow diagram of a method for automatically providing the documents, according to an embodiment of the present invention;

FIG. 4 is a second flow diagram of a method for automatically providing the documents, according to another embodiment of the present invention;

FIG. 5 is a third flow diagram of a method for automatically providing the documents, according to still another embodiment of the present invention;

FIG. 5A is a fourth flow diagram of a method for automatically providing the documents, according to one more embodiment of the present invention;

FIG. 6 is a first block diagram of a computer program product, according to an embodiment of the present invention;

FIG. 7 is a second block diagram of a computer program product, according to another embodiment of the present invention;

FIG. 8 is a third block diagram of a computer program product, according to still another embodiment of the present invention;

FIG. 8A is a fourth block diagram of a computer program product, according to one more embodiment of the present invention;

FIG. 9 is a diagrammatic illustration of a welcome screen of credit module portion of a graphical user interface, according to an embodiment of the present invention;

FIG. 10 is a diagrammatic illustration of a customer search dialog, according to an embodiment of the present invention;

FIG. 11 is a second view of the customer search dialog of FIG. 10;

FIG. 12 is a diagrammatic view of a customer selection screen, according to an embodiment of the present invention;

FIG. 13 is a diagrammatic illustration of a first portion of a first credit application entry screen, according to an embodiment of the present invention;

FIG. 14 is a diagrammatic illustration of a second portion of the first credit application entry screen, according to an embodiment of the present invention;

FIG. 15 is a diagrammatic illustration of a second credit application entry screen, according to an embodiment of the present invention;

FIG. 16 is a diagrammatic illustration of a third credit application entry screen, according to an embodiment of the present invention;

FIG. 17 is a diagrammatic illustration of a fourth credit application entry screen, according to an embodiment of the present invention;

FIG. 18 is a diagrammatic illustration of a fifth credit application entry screen, according to an embodiment of the present invention;

FIG. 19 is a diagrammatic illustration of a first portion of a sixth credit application entry screen, according to an embodiment of the present invention;

FIG. 20 is a diagrammatic illustration of a second portion of the sixth credit application entry screen, according to an embodiment of the present invention;

FIG. 21 is a diagrammatic illustration of a first portion of a credit application summary screen, according to an embodiment of the present invention;

FIG. 22 is a diagrammatic illustration of a second portion of the credit application summary screen, according to an embodiment of the present invention;

FIG. 23 is a diagrammatic illustration of a quote search screen, according to an embodiment of the present invention;

FIG. 24 is a diagrammatic illustration of a first quote entry screen, according to an embodiment of the present invention;

FIG. 25 is a diagrammatic illustration of a second quote entry screen, according to an embodiment of the present invention;

FIG. 26 is a diagrammatic illustration of a first portion of a configuration/usage screen, according to an embodiment of the present invention;

FIG. 27 is diagrammatic illustration of a second portion of the configuration/usage screen, according to an embodiment of the present invention;

FIG. 28 is a diagrammatic illustration of a asset summary screen, according to an embodiment of the present invention;

FIG. 29 is a diagrammatic illustration of a modify equipment screen, according to an embodiment of the present invention;

FIG. 30 is a diagrammatic illustration of an asset location, according to an embodiment of the present invention;

FIG. 31 is a diagrammatic illustration of a modify insurance screen, according to an embodiment of the present invention;

FIG. 32 is a diagrammatic illustration of a first portion of a modify configuration/usage second quote entry screen, according to an embodiment of the present invention;

FIG. 33 is a diagrammatic illustration of a second portion of the modify configuration/usage second quote entry screen, according to an embodiment of the present invention;

FIG. 34 is a diagrammatic illustration of a configuration/usage summary screen, according to an embodiment of the present invention;

FIG. 35 is a diagrammatic illustration of an add attachment screen, according to an embodiment of the present invention;

FIG. 36 is a diagrammatic illustration of an asset cash/flow/subsidy screen, according to an embodiment of the present invention;

FIG. 37 is a diagrammatic illustration of a first portion of a modify asset cash flow/subsidy screen, according to an embodiment of the present invention;

FIG. 38 is a diagrammatic illustration of a second portion of the modify asset cash flow/subsidy screen, according to an embodiment of the present invention;

FIG. 39 is a diagrammatic illustration of a modify skips screen, according to an embodiment of the present invention;

FIG. 40 is a diagrammatic illustration of a modify final payment screen, according to an embodiment of the present invention;

FIG. 41 is a diagrammatic illustration of an asset/create residual exception screen, according to an embodiment of the present invention;

FIG. 42 is a diagrammatic illustration of an asset finance screen, according to an embodiment of the present invention;

FIG. 43 is a diagrammatic illustration of a modify asset finance details screen, according to an embodiment of the present invention;

FIG. 44 is diagrammatic illustration of an asset trade in screen, according to an embodiment of the present invention.

### DETAILED DESCRIPTION

With reference to the drawings, and in operation, the present invention provides an automated computer based system 200, a method 300, 400, 500, and computer program product 600, 700, 800 for use in a financial transaction, i.e., a sale, lease or other agreement related to the exchange of goods or services.

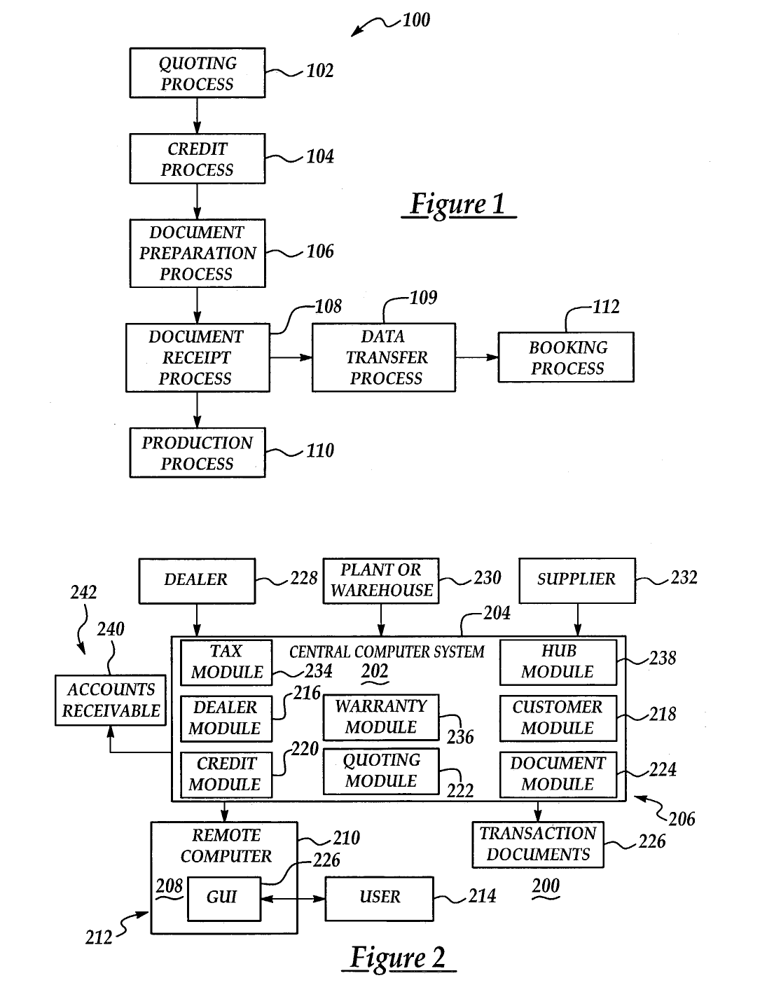

With specific reference to FIG. 1, the present invention may be utilized for the creation of a purchasing or leasing transaction 100 for products (items or equipment) or services, such as construction or agricultural equipment, engines, automobiles, boats, trucks, computer or electronic items, consumer items, or other consumer or commercial products or services. As described above, there may be three basic functions during the creation process: a quoting process (flow block 102), a credit process (flow block 104), and a document preparation process (flow block 106).

Generally, a customer desires to purchase or lease one or more products, such as construction or agricultural equipment, engines, computer or electronic items, consumer items, or any type of equipment, item, or service which may be bought or sold. The customer may contact a sales agent, who may be located at a dealer of the construction equipment, a financing company, or some other location. As described below, the sales agent utilizes the computer based system 200, method 300, 400, 500, and/or computer program product 600, 700, 800 to go through the quoting, credit and document preparation processes 102, 104, 106.

Alternatively, these processes 102, 104, 106 may be accomplished by the customer through a computer network, such as the internet, using an interactive or graphical user interface (see below).

In the quoting process 102, the agent works with the customer and determines the equipment which the customer wishes to purchase or lease and the monthly payment the customer desires. The desired monthly payment may be a maximum or minimum payment.

In one embodiment of the credit process 104, the sales agent requests a credit score for the customer (using data received from a credit bureau). This information, along with other information regarding the customer's history with the financing company, is used to determine whether to extend credit to the customer for the purchase or lease of the equipment and, if so, under what terms.

During the quoting and credit processes 102, 104, the sales agent requests and receives from the customer, transaction information. As described below, the agent enters this information into the system 200.

After the transaction documents have been prepared and delivered to the customer, the documents must be executed to complete or form the contract. In one embodiment, paper copies of the documents are manually signed and returned. In another embodiment, the documents are executed electronically and returned electronically, e.g., by email. Verification of the receipt of all required documents in performed in a document receipt process 108. If signed paper copies of the documents have been received, the verification process may be done manually, i.e., through a checklist (see below). Alternatively, receipt of electronically executed documents may be verified electronically and automatically. Signed paper copies or electronically may generally be referred to as the executed documents.

After the executed documents have been received, the data related to the transaction may be transferred over to an accounts receivable function in a data transfer process 109 (see below).

After the contract has been formed, the transaction may be linked to a production process 110 (see below).

Additionally, after all of the executed documents have been received, the transaction may be placed on the accounts receivable. Depending on the type of transaction, once it has been placed on the accounts receivable, the financing company may have ownership for book purposes (all or a portion of the revenue from the transaction may be treated as income) and/or the financing company may have ownership for tax purposes. For example, if the transaction is an operating lease, once all of the executed documents have been received and the transaction placed on the accounts receivable it is generally considered a fixed asset, i.e., the financing company has ownership of the underlying asset for book purposes and generally has ownership for tax purposes.

Booking of the transaction may also cause other actions to occur. For example, if a financial organization is providing financing for the sale or lease of equipment by a customer through a third party, such as a dealer, booking may cause funds to be transferred to the dealer for the amount financed and/or may cause an invoice to the customer to be generated. For example, a check may be automatically generated or money may be electronically transferred.

With specific reference to FIG. 2, an automated computer based system 200, which may be distributed or centralized, is used to automate many of the steps used in each process.

The automated computer based system 200 includes a finance computer application 202 implemented on a first computer system 204 located at a first location 206. In one embodiment, the finance computer application 202 is web-based and accessed through a web-browser, such as Microsoft Internet Explorer, available from Microsoft Corp. of Redmond, Wash.

A second computer application 208 provides additional functionality. In one embodiment, a user 214 interacts with the computer applications 202, 208 via a graphical user interface 212 (see below). The user 214 may be either the customer or the sales agent.

In one embodiment, the second computer application 208 may include one or more of the following modules: a tax module 234, a warranty module 236, and a hub module 238.

In a first embodiment, one or more modules 234, 236, 238 of the second computer application 208 are implemented on a second computer system or remote computer 210. The second computer application 208 is coupled to the first computer system 204 and is located at a second location 212.

In a second embodiment, one or more modules 234, 236, 238 of the second computer application 208 are implemented on the first computer system 204.

In the illustrated embodiment, an accounts receivable function is handled by a third computer application 240 implemented on a third computer system 242. The third or accounts receivable computer application 240, in one embodiment, handles the accounts receivable function including tracking accounts, generating invoices, registering payments and overdue payments. As discussed above, once a contract is formed, as indicated by the receipt of all executed documents, information regarding the transaction may be transferred from the central computer system 202 to the accounts receivable functions, i.e., the third computer system 242. When the transaction information is received and verified by accounts receivable, the transaction may then be booked. In one aspect of the present invention, when the transaction is booked, all or part of the revenue from the transaction may be treated as income. Furthermore, if the transaction provides financing to a customer for equipment purchased or leased from a third party, such as a dealer, funds for the equipment may be released to the dealer, e.g., issuance of a check or electronic transfer.

The tax module 234 may be used to determine taxes for a transaction in an automated manner. A set of contract characteristics and customer location information may be input by a user. A contract type, e.g., sale or lease, may be input by a user or may be determined as a function of the input contract characteristics and customer location information. The tax module 234 may also determine the appropriate set of tax rules, e.g., state and local tax rules, as a function of the customer location information and contract type. Further the tax module 234 may determine a tax amount as a function of the contract characteristics, the contract type and the set of tax rules.

For example, the tax module 234 may store a set of state and local tax rules in a database (not shown). The tax module 234 is adapted to receive a set of contract characteristics and the customer location information input by a user and automatically determine an appropriate set of state or local tax rules to apply as a function of either the customer location information, the contract characteristics, and/or contract type. In other words, based on the user's input data, the tax module 234 retrieves the appropriate set of state and local tax rules from the database. In one embodiment, the customer location information includes a zip code.

The user may input the set of contract characteristics and customer location information to the tax module 234 through a user interface (not shown). Alternatively, the set of contract characteristics, contract type, and customer location information may be entered into the tax module 234 through a data file.

The tax module 234 may be further adapted to determine a contract type based on the contract characteristics under the set of state and local tax rules and to calculate a tax amount based on the contract characteristics, the contract type and the set of state and local tax rules.

In one embodiment, the contract type is one of a lease and a financing contract. In another embodiment, the contract type is one of an operating lease, a true lease, a finance option lease, a finance lease purchase with mandatory final payment, a government lease purchase and an installment sale.

These terms are generally defined below. However, each state may define the terms differently. For a particular set of state and local tax rules, the jurisdictional definitions will be applied.

Operating Leases are leases that are fixed assets for book purposes, which may or may not pass the tax rules. The set of rules are applied to the lease and include a four item-test. If the contract does not pass any of the four tests then it will be considered an operating lease. Under an operating lease, the lessor has ownership of the asset for book purposes and generally has ownership for tax purposes. The lessee or customer is simply paying for the use of the asset and has no equity built up in the asset. In general, the four tests are:

the lease period is more than a percentage, e.g., 75%, of the economic life of the asset

the payments are more than a percentage, e.g., 90%, of the net present value (NPV) of the asset

there is an automatic transfer of the asset at the end of the lease; and

the lease contains a bargain purchase option.

True Lease (or tax lease) are leases in which there is no equity built up by the customer in the equipment. In general, if there is equity built up, then the customer may be buying the equipment, as opposed to leasing it. If the agreement or contract is structured such that the customer is buying the equipment, then the lessor does not get to declare the depreciation of the equipment. If the lease is a true lease, then the financing company will not own the equipment for book purposes, but will be the owner for tax purposes. For example, under a true lease, the financing company would be able to declare accelerated depreciation for Federal and State income tax purposes. However, this would not affect the determination of the state's sales tax since each state's sales tax rules are independent of the income tax rules.

Finance Option Lease: Under a finance option lease, the financing company is not the owner of the equipment. The customer builds up equity in the equipment during the course of the lease. The customer may have a bargain option for the purchase of the equipment at the end of the lease and have accumulated equity in the equipment at that time. Therefore, the lessee may normally take the depreciation in the equipment.

Finance Lease Purchase with Mandatory Final Payment: If there is a mandatory final payment, the lease is normally a sake and the lessee can take the depreciation for Federal Tax purposes. Thus, the lease is not a lease for Federal purposes. For sales tax purposes, ownership will again be considered under the relevant state rules.

Government Lease Purchase: Government lease purchases have most of the sane characteristics ass the Finance Lease contract. The main differences are related to the tax language in the contract. There cannot be an option at the end of the contract, but there can be a balloon payment up to 80% of the fair market value of the equipment at the end of the contract. In addition, a government lease purchase can only be offered to tax exempt entities, not including federal government agencies.

Installment Sales—Dealer Equipment: The financing company buys the contract, not the equipment. Thus, the customer and the dealer are responsible for the sales and/or use taxes.

Installment Sales—Financing Company Equipment: The financing company owns the equipment and is therefore responsible for the sale and/or use taxes.

The set of state and local tax rules may include exemption and/or partial exemption rules includes special state and/or local rulings, e.g., a related to a power output (typically in terms of horsepower) and or the type of equipment. The type of equipment could include a product family, e.g., backhoe loader and/or a model number, e.g., 420.

In a further embodiment, the tax module 234 is adapted to determine a paying party who will pay the tax amount as a function of the set of state and local rules. The paying party is the dealer, the financing company or the customer. The tax module 234 also determines how the tax is to be paid, e.g., upfront or with a stream of payments as a function of the set of state and local tax rules.

The state and local tax rules includes maximum and double tax rules. The determination of the taxes due take into account the maximum and double tax rules. In one embodiment, the database includes rules for each locality's sales, use, rental and personal property taxes. Alternatively, the database is configured to access the appropriate rules and regardless of the location of the rules.

In one embodiment, the tax module 234 is adapted to generate or print an invoice for the tax amount using, e.g., a printer (not shown).

The set of contract characteristics may include, but is not limited to:

a residual amount due at end of contract,

a purchase price of the equipment,

a type of purchase option,

a mandatory final payment, and/or

a trade-in.

The type of purchase option may be one of fair market value, a CVO, a bargained price, and/or none.

The warranty module 236 may be used to determine a price associated with a warranty for equipment in a transaction. The warranty module 236 may receive input from the user, responsively establishes an identifier associated with the equipment, receives a first set of warranty characteristics and determines a baseline premium based on the identifier and the set of warranty characteristics. Additionally, the warranty module 236 may establish a second set of warranty characteristics, determine at least one modifier as a function of the second set of warranty of characteristics, and modify the baseline premium as a function of the at least one modifier to determine the warranty price.

The warranty module 236 provides pricing for the extended warranty based on a number of parameters (see below). The warranty module 236 may be adapted to establish the cost or price of the warranty to the customer. Alternatively or additionally, if the extended warranty is to be provided by a third party, such as the manufacturer, the warranty module 236 may be adapted to establish the cost or price of the warranty to the dealer or seller.

In one embodiment, the warranty module 236 stores actuarial and related data. In one aspect of the present invention the warranty module 236 is implemented within a spreadsheet file adapted to be opened/executed via a spreadsheet program, such as Microsoft Excel. The warranty module 236 includes actuarial data which is based on actual data using known techniques. In one embodiment, the actuarial data is represented on various sheets within the spreadsheet file. It should be noted that the warranty module 236 may also be implemented using a database program, a standalone program or other suitable tool.

In one embodiment, the warranty module 236 is adapted to receive input from a user, responsively establish an identifier associated with the item or equipment, e.g., a serial number, establishing a first set of warranty characteristics and determine a baseline premium based on the identifier and the first set of warranty characteristics. In one embodiment, the identifier and first set of warranty characteristics (and other inputs) are input by the user. In another embodiment, the identifier and first set of warranty characteristics are established based on information received from other systems.

The warranty module 236 is further adapted to establish a second set of warranty characteristics, determine at least one modifier as a function of the second set of warranty of characteristics, and modify the baseline premium as a function of the at least one modifier to determine the warranty price.

In one embodiment, a graphical user interface (GUI) is implemented on an input sheet (not shown) within the spreadsheet file. The input sheet includes a plurality of lists from which the user may select and/or enter information. Entries in one of the lists may change the options in other lists.

In one embodiment, the first set of warranty characteristics includes a geographic region.

In one aspect of the present invention, the warranty module 236 is adapted to allow the user to select a term for the warranty. In one embodiment, the baseline premium is determined or modified as a function of the geographic region, the term, and the identifier. For example, each country may correspond to a geographic region, e.g., Asia, Europe, or North America. The spreadsheet file includes a sheet corresponding to each geographic region. Each sheet includes a plurality of premiums for each model of equipment in the corresponding geographic region. These premiums are based on actual repair/warranty data and derived using known methods. Additionally, there may be separate sheet for parts and labor (see below).

Furthermore, as explained below, the term selected by the user may be divided into a plurality of sub-terms, typically years, for example first and second sub-terms. A baseline premium (e.g., first term premium and second term premium) may be determined using the sheet in the spreadsheet file for each sub-term.

In one embodiment, the item equipment includes first and second portions and the warranty module 236 is adapted to allow the user to select a term for the first portion and a term for the second portion. In general the first and second portions of the equipment are used where the equipment can be separated into two parts and where a separate warranty (term and parameters) is appropriate, e.g., the powertrain and tires of an automobile or the powertrain and hydraulics system of construction equipment.

In one embodiment, the user may select a term expressed in a length of time from a purchase or lease date and a term expressed in number of hours of operation. Generally, the warranty is expressed only in terms of one or the other (length of time from the purchase or lease date or hours of operation). The warranty module 236, based on the user input information is adapted to determine which is more appropriate. For example, if a requested term defined by hours is greater than the average number of hours for the equipment at issue, this may signify that the customer intends to use the equipment more than the equipment is typically used. In this situation, it would be appropriate to define the warranty in terms of hours of operation.

In one embodiment, the second set of warranty characteristics includes warranty coverage. The warranty module 236 is adapted to establishing a level of coverage of the equipment as a function of user input and to determine a coverage modifier as a function of the level of coverage. As stated above, the equipment includes a first portion and a second portion. The level of coverage is one of warranty for the first portion and warranty for the first and second portions. In the illustrated embodiment, there are three levels of coverage: coverage for the powertrain, coverage for the powertrain and the hydraulics system, and coverage for total equipment.

In one embodiment, the second set of warranty characteristics includes the country of operation. The warranty module 236 is adapted to determine a country modifier as a function of the country of operation. As data is collected regarding warranty costs and repairs, the data may reflect other changes in the costs and repairs which are otherwise not accounted for in the data in the spreadsheet file. The country modifier is aimed at accounting for such differences. The country modifiers are located on a sheet within the spreadsheet which contains a list of country modifiers based at least on country and identifier. The country modifier is selected from the appropriate sheet and used in subsequent calculations. The geographic region includes parameters which may cut across country lines. The country of operation characteristics takes into account factors particular to a specific country.

In one embodiment, the second set of warranty characteristics includes an average number of hours of operation in the country of operation. The warranty module 236 is adapted to determine an average number of hours of operation modifier as a function of the country of operation and the identifier. For example, if the expected number of hours of operation of the equipment is different, either higher or lower, then the premium can be adjusted, either higher or lower.

In one embodiment, the user may identify whether or not the transaction is with a government. The warranty module 236 is adapted to determine a government modifier if the transaction is with a government.

In one embodiment, the user identifies if the transaction includes a customer service agreement. The warranty module 236 is adapted to determine a customer service agreement modifier if the transaction includes a customer service agreement. For example, if a customer service agreement has been purchased, a discount of 5% or 10% may be given.

In one embodiment, the warranty module 236 is adapted to establish an industry segment in which the equipment is to be used and to determine an industry segment modifier as a function of the industry segment and the identifier. The user selects the industry segment in which the equipment is to be used. If the industry segment in which the equipment is being used is different than its intended industry, then the extended warranty premium may be increased.

For example, if an agricultural tractor where being used in building construction, the equipment may experience a harsher operating environment.

In one embodiment, the warranty module 236 may determine a loss ratio.

For example, premium costs are the expected costs to the dealer or manufacturer based on the expected repair costs. The loss ratio takes into account, among other things, account overhead, investment income, and profit. The premium for the extended warranty may then be calculated as the sum of the following for each sub-term: the combined pure premium multiplied by the modifiers.

The hub module 238 is used to exchange information between systems or modules. The hub module 238 delivers the information from a first system to a hub application (not shown), receives the information at the hub module and maps the information at the hub module 238 into a predefined data structure. The hub module 238 may be used to automatically update information stored on at least one other system using the predefined data structure.

In one aspect, the hub module 238 is adapted to translate the information received from the first system from a first data format to a second data format. In one embodiment of the present invention, each system or module includes a connecting computer program application or connection application (not shown) which is adapted to translate the information prior to being sent to the hub receiving from the first system from a first data format to a second data format.

In one aspect of the present invention, the hub module 238 is synchronous. For example, in one embodiment, the information from the first system is sent to the hub at predetermined intervals. Additionally, the information stored on the at least one other system is updated at predetermined intervals.

In another aspect of the present, the hub module 238 is asynchronous. In other words, information is not exchanged on predetermined intervals, but rather is updated in packets.

The hub module 238 uses a publish and subscribe process. In one embodiment, the at least one other system is adapted to generate a request for an update. The hub module 238 is adapted to receive the request and automatically update the information on the at least one other system using the predefined data structure in response to receiving the request.

In one aspect of the present invention, the hub module 238 is adapted to automatically update the information stored on at the least one other system using the predefined data structure using direct mapping. In one embodiment, the predefined data structure includes a plurality of predefined locations. The information to be exchanged is composed of a plurality of data elements. Each data element is mapped to a predefined location within the data structure.

In another aspect of the present invention, the hub module 238 includes queuing software applications which couple the applications to the hub module 238.

In one embodiment, the queuing application is implemented using a messaging computer program product. One suitable messaging computer program product is available from IBM of Armonk, N.Y. as WebSphere MQ Queue Manager (formerly, MQSeries Queue Manager). In one aspect of the present invention, the messaging computer program product provides once-only guaranteed delivery. In another aspect of the present invention, the messaging computer program product provides prioritizing of message delivery.

In another aspect of the present invention, the hub module 238 includes a set of transformation functions for receiving the information at the hub module 238 and mapping the information at the hub module 238 into the predefined locations of the predefined data structure.

The first and second computer systems 204, 210 are linked via a computer network, for example, a wide area network (WAN) or the internet.

In one embodiment, the finance computer application 202 includes a dealer module 216, a customer module 218, a credit module 220, a quoting module 222, and a document module 224.

The dealer or sales module 216 gives, to a dealer for the equipment or items at issue or to a sales agent, access to the credit, quoting and document modules 220, 222, 224. Additionally, the dealer module 216 provides online access to time sensitive information, e.g., financing and insurance rates, automated access to reports, such as dealer activity and daily funding reports, enrollments in marketing and warranty plans.

The customer module 218 gives to the customer access to the credit, quoting and document modules 220, 222, 224. Additionally, the customer module 218 provides online access to account information, e.g., account balance, principal balance, interest paid, last paid date, next due date, mail date, invoice number of last mailed invoice, payoff balance at both the contracts and customer levels, payoff good through data at both the customer and contract levels, and daily per diem at both the customer and contract levels. The customer may also be able to request invoices be mailed or faxed directly through the customer module 218. Further, the customer may also be able to make payments, e.g., electronic transfers or via a credit card, through the customer module 218.

The credit module 220 allows the user 214 to enter, modify, or access a credit application. Based on the credit application, a credit report from a consumer credit bureau is retrieved and a credit score is calculated. Both the credit score and the credit report may be viewable through the credit module 220.

In one embodiment, the credit module 220 is adapted to add or subtract from the credit score based on other available data, e.g., the pay history of the customer at the finance company and/or available collateral.

The quoting module 222 allows the user 214 to create and/or edit quotes. In one embodiment, each quote is for a single asset (item or equipment). In another embodiment, a quote may contain more than one asset, i.e., multiple items or pieces of equipment. In one embodiment, the user 214 can enter trade-in, attachment or accessory information, taxes, fees, down payment amounts and determine a total financed amount. The quoting module 222 may also be used to calculate insurance, e.g., physical damage insurance, and any trade-in details.

In one embodiment, the quoting module 222 is used to create quotes for financed transactions, such as, leases (lease quotes). The lease quotes are then sent to the credit module 220 (for credit scoring purposes) and the document module 224.

The document module 224 utilizes information recorded and/or created by the credit and quoting module 220, 222 to create the transaction documents required for the transaction. The number and type of documents required may be fixed or may be dependent upon the transaction details, e.g., the type of financing.

For example, in one embodiment, an installment sales contract includes a basic document set which may include eight documents, a cover letter, a standard installment sales contracts, an attachment, a payment schedule, a blanket assignment letter, an assignment letter, a back page, a customer verification form and an insurance letter.

In one embodiment, using the credit, document and quoting modules 220, 222, 224, the finance computer application 202 is adapted to establish a quote and to establish a set of terms for the transaction as a function of the quote. The quote includes at least one item included in the transaction. The set of terms includes an amount to be financed. The finance computer application 202 is also adapted to automatically provide a set of financial documents for the transaction as a function of the quote and the set of transaction terms. In one embodiment, the financial documents include the formal documents for the transaction. In another embodiment, the financial documents include a summary of the terms of the transaction.

The finance computer application 202 is further adapted to establish at least one changed parameter after a start date of the transaction, modify the terms of the transaction in response to the at least one changed parameter, and automatically provide a set of revised financial documents for the transaction as a function of the modified terms of the transaction.

The transaction has a start date and an end date. After the start date, one or more conditions, i.e., parameters may change which may require terms of the transaction to be changed. For example, if the equipment covered by the transaction included agricultural equipment and weather conditions negatively affect the user's crop, this may have a negative effect on the cash flow of the user. The user may therefore have a reduced ability to make payments under the current finance terms. The automated computer based system 200, therefore, allows the terms of an existing transaction to be modified within the quoting or credit modules 220, 222 and new (revised) documents to be generated. Examples of terms which may be modified include, but are not limited to, a residual value associated with the transaction or one or more payments.

As discussed below, in one embodiment the credit module 220 of the finance computer application 202 is adapted to allow the user 214 to fill out a credit application and is adapted to establish a credit report as a function of the credit application. The credit module 220 then establishes the amount to be financed as a function of the credit report.

In one embodiment, the second computer application 208 includes a graphical user interface 226.

The first computer system 204 may also be coupled to a dealer 228 and/or a plant or warehouse 230 and/or a supplier 232 to the plant or warehouse 230. In another embodiment the finance computer application 202 is adapted to link the transaction with the production process 110. For example, the production process 110 may allow the customer or agent to do one or more of the following: determine a delivery date to the customer, check dealers (local or national) for availability, check manufacturing inventory, check progress of equipment in the production process, and/or place the ordered equipment or item into the production queue. Additionally, the production process 110 may also be tied into a supply system (not shown) which allows supplies, e.g., parts, required for the ordered equipment to be ordered and/or shipped by a supplier to the manufacturer.

In one embodiment, the finance computer application 202 is adapted to establish a delivery date for one or more items associated with the transaction.

The delivery date is based on information received from the dealer 228 or the plant or warehouse 230. For example, the deliver date may be determined by establishing machine availability, establishing transportation availability, and responsively determined the delivery date. The machine availability may be determined by establishing dealer and/or manufacturer's inventory and responsively determined machine availability as a function thereof.

In another embodiment, the finance computer application 202 is adapted to identify a dealer through which the one or more items associated with the transaction will be provided. In one aspect, the item may be available through a plurality of dealers. The finance computer application 202 may identify: (1) the closest dealer (geographically) to the customer and/or (2) the dealer which has the item in stock and/or (3) the next dealer who will have the item available.

In still another embodiment, the finance computer application 202 is adapted to send a signal to the manufacturer. In response to receiving the signal, the manufacture may queue up the item in its manufacturing process. For example, if an item cannot be found in inventory and is not in progress, then it may be queued up to be manufactured.

In another embodiment, the finance computer application 202 is adapted to send (or cause the sending of) a signal to the supplier 232. The supplier 232 supplies material used in the manufacture or assembly of the item. The signal is used to by the supplier 232 as an order for the material desired to manufacture or assembly the item ordered by the customer. For example, as a product is committed to a buyer, the system 200 may, either directly or use an inventory replenishment program, order parts or material to be used to build the product ordered or a machine that will replace the product sold.

In one aspect of the present invention, a computer based method for use in a financial transaction is provided. The method includes the steps of establishing a quote for the transaction. The quote includes at least one item included in the transaction. The method also includes the steps of establishing a set of terms for the transaction, the terms including an amount to be financed, establishing at least one changed parameter after a start date of the transaction, and modifying the terms of the transaction in response to the at least one changed parameter.

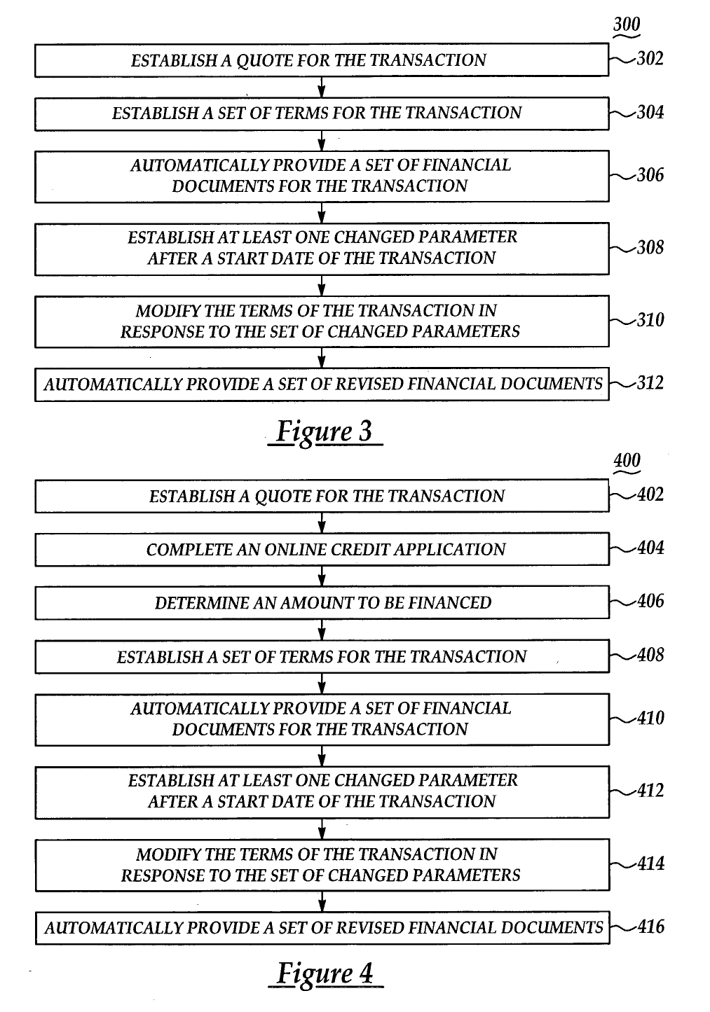

With reference to FIG. 3, a computer based method 300 for use in a financial transaction, according to a first embodiment of the present invention will now be discussed. In a first process block 302, a quote for the transaction is established. The quote includes at least one item included in the transaction. In a second process block 304, a set of terms for the transaction is established. The set of terms includes an amount to be financed. In one embodiment, the set of terms includes terms which are entered by the user 214 and calculated terms.

In a third process block 306, a set of financial documents for the transaction is generated as a function of the quote and the set of transaction terms. In a fourth process block 308, at least one changed parameter is established after a start date of the transaction. In a fifth process block 310, the terms of the transaction are modified in response to the at least one changed parameters. In a sixth process block 312, a set of revised financial documents for the transaction is provided as a function of the modified terms of the transaction.

With reference to FIG. 4, a computer based method 400 for use in a financial transaction, according to a second embodiment of the present invention will now be discussed. In a first process block 402, a quote for the transaction is established. The quote includes at least one item included in the transaction. In a second process block 404, an online credit application is completed by the user 214.

In a third process block 406, an amount to be financed is determined as a function of the quote and the credit application. In a fourth process block 408, a set of terms for the transaction is established as a function of the quote, the credit application, and the amount. In a fifth process block 410, a set of financial documents for the transaction is provided as a function of the of transaction terms.

In a sixth process block 412, at least one changed parameter is established after a start date of the transaction. In a seventh process block 414, the terms of the transaction are modified in response to the at least one changed parameter. In an eighth process block 416, a set of revised financial documents for the transaction are automatically provided as a function of the modified terms of the transaction.

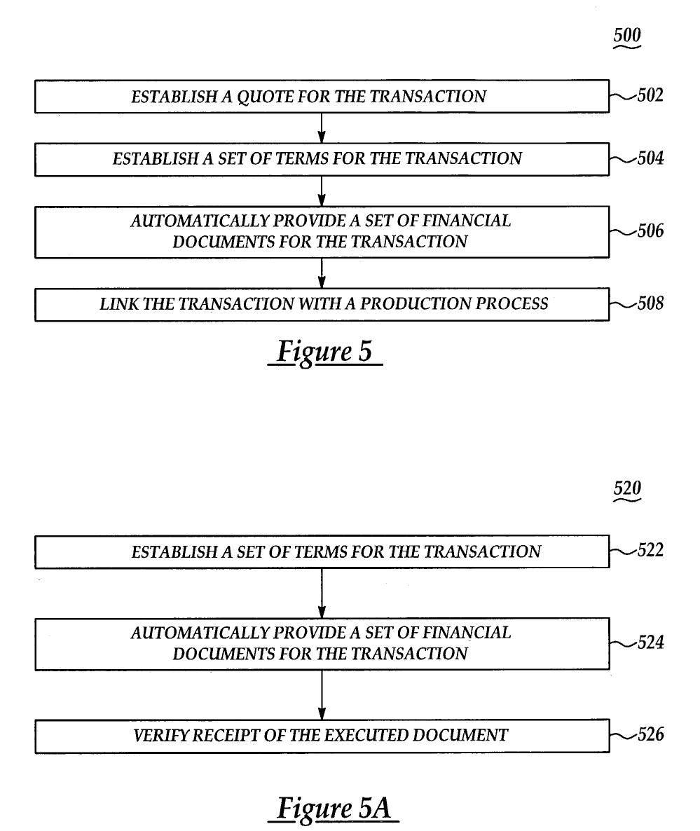

With reference to FIG. 5, a computer based method 500 for use in a financial transaction, according to a third embodiment of the present invention will now be discussed. In a first process block 502, a quote for the transaction is established. The quote includes at least one item included in the transaction. In a second process block 504, a set of terms for the transaction is established. The set of terms includes an amount to be financed. In a third process block 506, a set of financial documents for the transaction are automatically provided as a function of the item and the set of transaction terms. In a fourth process block 508, the transaction is linked with a production process.

With reference to FIG. 5A, a computer based method 520 for use in a financial transaction, according to a fourth embodiment of the present invention will now be discussed. In a first process block 522, a set of terms for the transaction is established. The set of terms includes an amount to be financed. In a second process block 524, a set of financial documents for the transaction are automatically provided as a function of the item and the set of transaction terms. In a third process block 526, receipt of the executed documents is verified.

In one embodiment, the documents are provided to the customer as paper copies, which require manual or handwritten signatures by the customer in order to form a contract. In another embodiment, the documents may be provided electronically and a digital signature may be used.

If the documents have been executed electronically, the documents along with a digital signature may be received electronically and verified as they are received.

If the documents were manually signed, the executed documents must be reviewed and verified to the system 200. Generally, this would be accomplished through the user interface 226 (see below).

Once receipt of all required documents is verified (either manually or electronically), the transaction may be booked into the accounts receivable computer application 240. In the illustrated embodiment, this requires information regarding the transaction to be sent to the accounts receivable application 240. In one embodiment, verification of the receipt of all required documents triggers the transfer of data. In another embodiment the, user 214 may initiate the transfer of data to the accounts receivable application 240 and the booking of the transaction in the accounts receivable application 240 through manipulation of the user interface 226. This may be done simultaneously, through actuation of a single button (not shown), or separately, where one button transfers the data and another button books the transaction.

As discussed above, booking of the transaction refers to “placing the transaction in the accounts receivable”. For example, once a transaction has been, all or a portion of the revenue from the transaction may be considered income. Additionally, when the financial transaction provides financing to a customer for an item provided by a third party, e.g., a dealer, once the transaction has been booked, funds for the item may be automatically transferred to the third party. The transfer of funds may be through the automatic generation of a check or an electronic transfer. Furthermore, once the transaction has been booked, an invoice to the customer for fees and/or payments related to the transaction may be automatically generated.

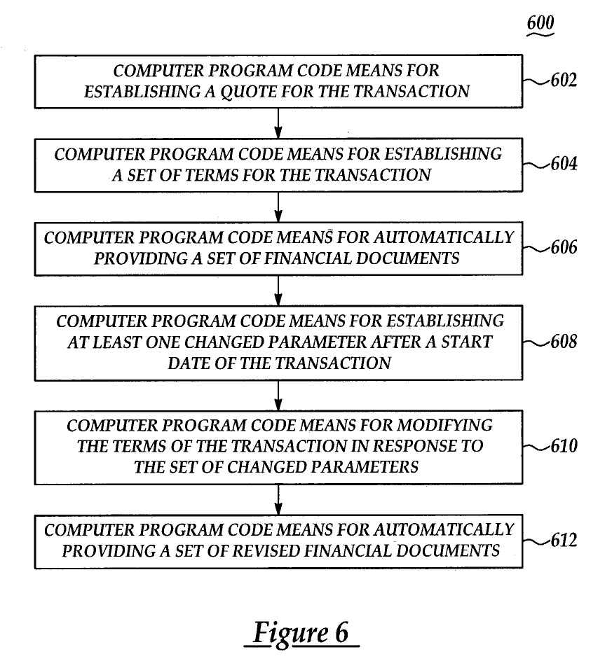

With reference to FIG. 6, a computer program product 600 for use in a financial transaction, according to an embodiment of the present invention includes computer readable program code means 602 for establishing a quote for the transaction, the quote including at least one item included in the transaction, and computer readable program code means 604 for establishing a set of terms for the transaction, including an amount to be financed. The computer program product further includes computer readable program code means 608 for establishing at least one changed parameter after a start date of the transaction and computer readable program code means 610 for modifying the terms of the transaction in response to the at least one changed parameter.

A computer program product 600 for use in a financial transaction, according to another embodiment of the present invention includes computer readable program code means 602 for establishing a quote for the transaction, the quote including at least one item included in the transaction, computer readable program code means 604 for establishing a set of terms for the transaction, including an amount to be financed, and computer readable program code means 606 for automatically providing a set of financial documents for the transaction as a function of the quote and the set of transaction terms. The computer program product further includes computer readable program code means 608 for establishing at least one changed parameter after a start date of the transaction, computer readable program code means 610 for modifying the terms of the transaction in response to the at least one changed parameter, and computer readable program code means 612 for automatically providing a set of revised financial documents for the transaction as a function of the modified terms of the transaction.

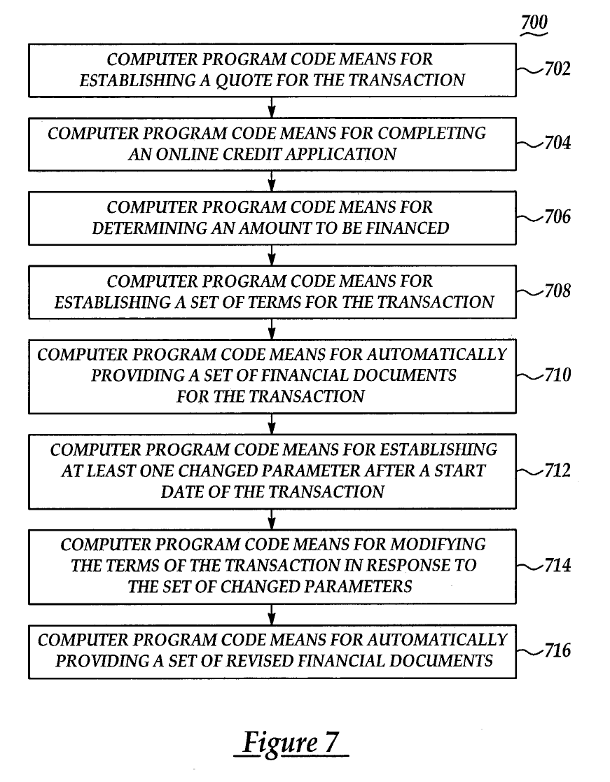

With reference to FIG. 7, a computer program product 700 for use in a financial transaction, according to another embodiment of the present invention includes computer readable program code means 702 for establishing a quote for the transaction, computer readable program code means 704 for completing an online credit application, computer readable program code means 706 for determining an amount to be financed as a function of the quote and the credit application, and computer readable program code means 708 for establishing a set of terms for the transaction as a function of the quote, the credit application, and the amount. The computer program product 700 also includes computer readable program code means 710 for automatically providing a set of financial documents for the transaction as a function of the of transaction terms, computer readable program code means 712 for establishing at least one changed parameter after a start date of the transaction, computer readable program code means 714 for modifying the terms of the transaction in response to the at least one changed parameter, and computer readable program code means 716 for automatically providing a set of revised financial documents for the transaction as a function of the modified terms of the transaction.

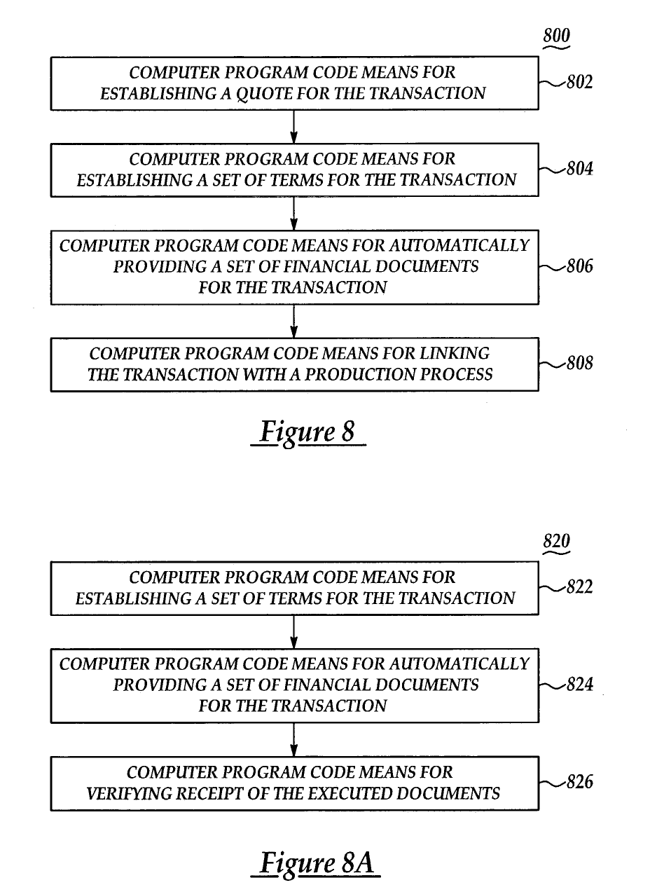

With reference to FIG. 8, a computer program product 800 for use in a financial transaction, according to another embodiment of the present invention includes computer readable program code means 802 establishing a quote for the transaction, the quote including at least one item included in the transaction, computer readable program code means 804 establishing a set of terms for the transaction, including an amount to be financed, computer readable program code means 806 automatically providing a set of financial documents for the transaction as a function of the item and the set of transaction terms, and computer readable program code means 808 linking the transaction with a production process.

With reference to FIG. 8A, a computer program product 820 for use in a financial transaction, according to still another embodiment of the present invention includes computer readable program code means 822 for establishing a set of terms for the transaction. The computer program product 820 also includes computer readable program code means 824 for automatically providing a set of financial documents for the transaction as a function of the quote and the set of transaction terms, and computer readable program code means 826 for verifying receipt of executed documents.

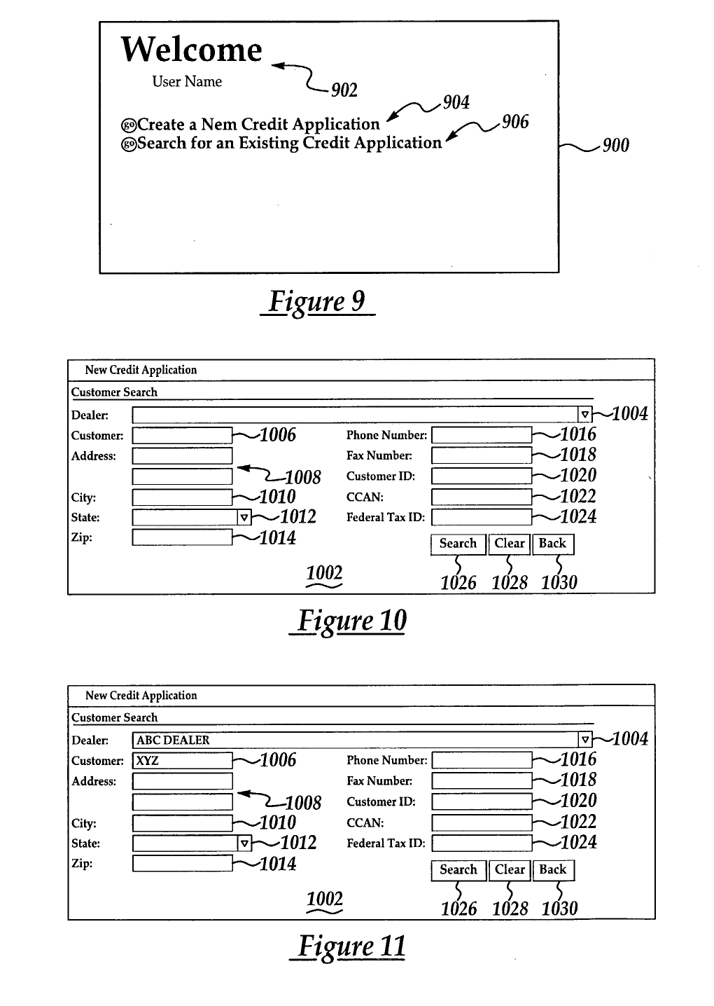

With reference to FIGS. 9-53, the finance computer program 202 includes a graphical user interface 226 as discussed above. In the illustrated embodiment, the finance computer program 202 is used to arrange financing for construction, earthmoving and/or agricultural equipment which is sold through dealers.

Illustrative portions of the graphical user interface 226 implemented for the credit module 220 are shown in FIGS. 9-22 and will now be discussed.

With reference to FIG. 9, after the user 214 enters a user name (and password), the credit module 220 presents a welcome screen 900. The welcome screen 900 may identify the current user 902 (i.e., “user name”) and includes first and second selections 904, 906. Selection by the user 214 of the first selection 904 begins a sub-process to create a new credit application and selection by the user 214 of the second selection 906 begins a sub-process to search for and edit an existing credit application.

For purposes of explanation, the following discussion revolves around the creation of a new credit application. However, similar screens for the search and editing of an existing credit application may be used.

With reference to FIG. 10, with selection of the first selection 904, a search dialog 1002 is displayed. The customer search dialog 1002 is used to enter customer information The customer search dialog 1002 includes a dealer drop down list 1004, a customer text entry box 1006, at least one address text entry box 1008, a city text entry box 1010, a state drop down list 1012, a zip code text entry box 1014, a phone number text entry box 1016, a fax number text entry box 1018, a customer ID entry box 1020, a text entry box 1022, and a federal tax ID entry box 1024. The customer search dialog box 1002 also includes a search button 1026, a clear button 1028, and a back button 1030.

To search for an existing customer, the user 214 may enter information in one or more of the drop down lists 1004, 1012 and/or text entry boxes 1006, 1008, 1010, 1014, 1016, 1018, 1020, 1022, 1024 and activate the search button 1026. Activation of the clear button 1028 removes any entered information on the search customer dialog 1002. Activation of the back button 1030, returns the user to the welcome screen 900.

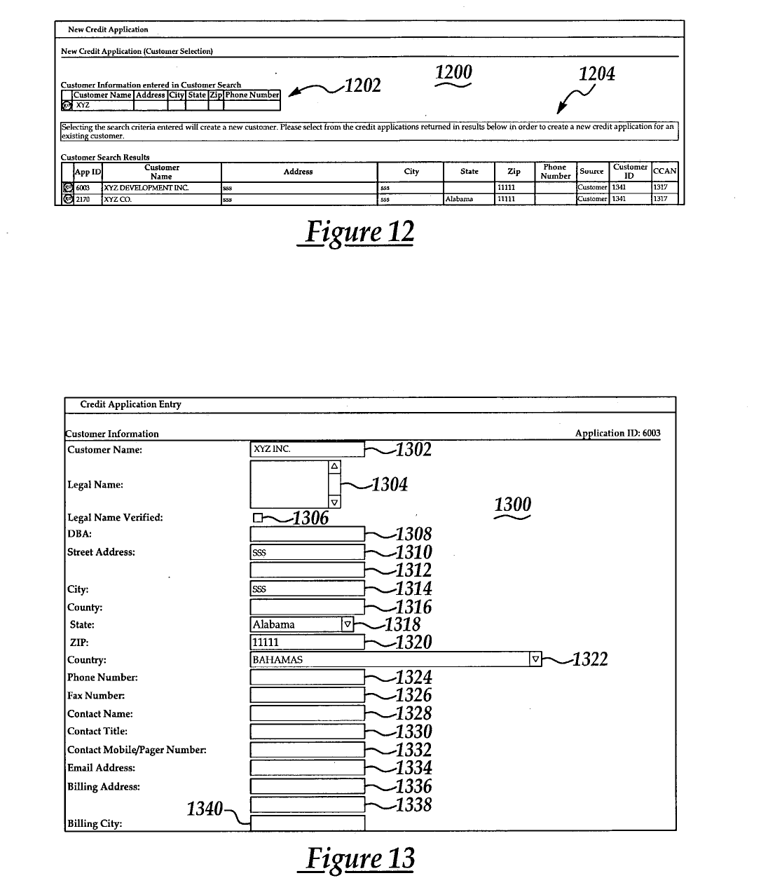

For example, as shown in FIG. 11, the dealer “ABC DEALER” has been selected in the dealer drop down list and “XYZ” has been entered into the customer text entry box 1006. With reference to FIG. 12, activation of the search button 1026 displays a customer selection screen 1200. The customer selection screen 1200 includes a customer entered information summary area 1202 and a customer search results list 1204. The customer entered information summary area 1202 displays a summary of the information entered on the search dialog 1002. The customer search results list 1204 lists all of the existing customers which meet the entered criteria. In the illustrated example, two customers, “XYZ Development Inc.” and “XYZ Co.” meet the entered criteria. As shown, the customer search results list 1204 displays a summary of information about each listed customer. In the illustrated embodiment, the following information is displayed: (existing) credit application ID, customer name, street address, city, state, zip, phone number, source, customer ID, and CCAN.

In the illustrated embodiment, the graphical user interface 226 is implemented as a web page and displayed using a web browser, such as Microsoft Internet Explorer. The web browser includes forward and back buttons (not shown). To go to a previous page, the user 214 may use the back button. To select a customer from customer search results list 1204, the user 214 activates the customer name (e.g., by clicking or double clicking on the customer name).

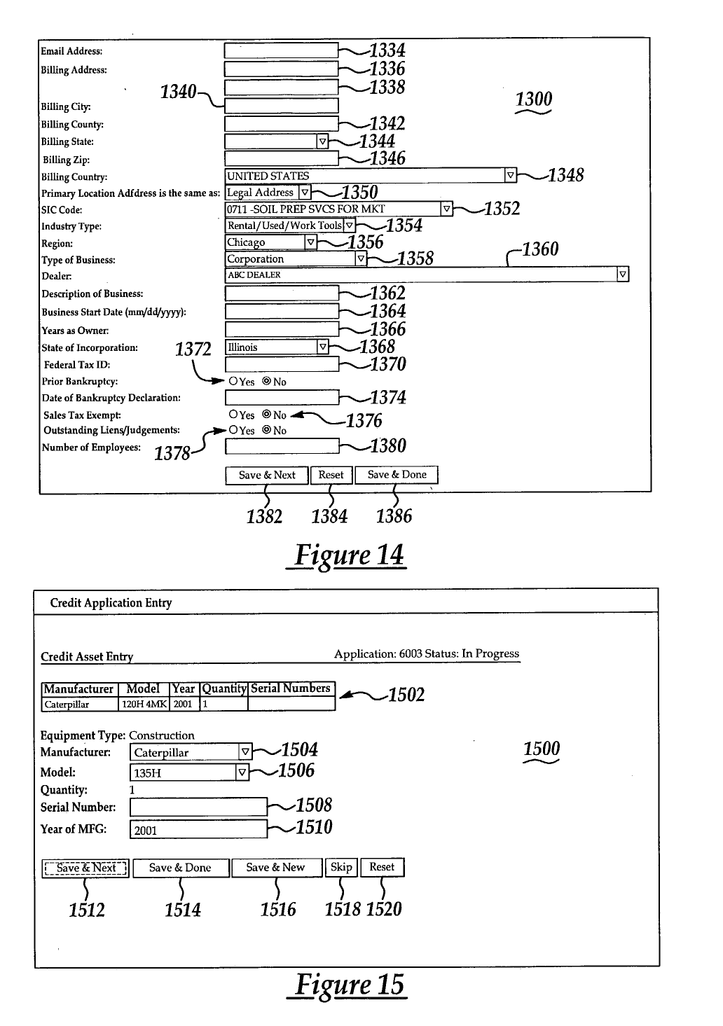

With reference to FIGS. 13-20, once a customer has been selected, a plurality of credit application entry screens are displayed. With specific reference to FIGS. 13 and 14, first and second portions of a first credit application entry screen 1300 are shown. An application ID is automatically assigned and displayed in the upper right corner of the first credit application entry screen 1300.

If the customer does not exist in the automated computer based system 200, similar screens may be used to enter the customer data.

The first credit application entry screen 1300 includes a customer display box 1302, a legal name entry box 1304, a legal name verified check box 1306, a doing business as (“DBA”) text entry box 1308, a plurality of address text entry boxes 1310, 1312, a city text entry box 1314, a country text entry box 1316, a state drop down list 1318, a zip code text entry box 1320, a country drop down list 1322, a phone number text entry box 1324, a fax number text entry box 1326, a contact name text entry box 1328, a contact title text entry box 1330, a contact mobile/pager number text entry box 1332, an email address text entry box 1334, a plurality of address text entry boxes 1336, 1338, a billing city text entry box 1340, a billing county text entry box 1342, a billing state text entry box 1344, a billing zip text entry box 1346, a billing country drop down list 1348, a primary location same as drop down list 1350, an SIC code drop down list 1352, an industry type drop down list 1354, a region drop down list 1356, a type of business drop down list 1358, a dealer drop down list 1360, a description of the business text entry box 1362, a business start date text entry box 1364, a years as owner text entry box 1366, a state of incorporation drop down list 1368, a federal tax ID text entry box 1370, a set of prior bankruptcy yes/no check boxes 1372, a date of bankruptcy text entry box 1374, a set of sales tax exempt text yes/no check boxes 1376, a set of outstanding lien/judgments yes/no check boxes 1378, and a number of employees text entry box 1380.

The first credit application entry screen 1300 also includes a save & next button 1382, a reset button 1384, and a save & done button 1386. Any information already entered in the system is displayed in the fields.

Activation of the save & next button 1382, saves any entered or modified data and proceeds to the next entry screen. Activation of the reset button 1384 clears all data on the entry screen 1300. Activation of the save & done button 1386 saves any entered or modified data and returns to the welcome screen 900.

With reference to FIG. 15, a second credit application entry screen 1500 is displayed. The second credit application entry screen 1500 allows the user 214 to add assets to the credit application. The second credit application entry screen 1500 includes a list 1502 of assets already on the application. The second credit application entry screen 1500 also includes a manufacturer drop down list 1504, a model drop down list 1506, a serial number text entry box 1508, and a year of manufacture text entry box 1510. The second credit application entry screen 1500 also includes a save & next button 1512, save & done button 1514, a save & new button 1516, a skip button 1518, and a reset button 1520. The user 214 may select the equipment to be added to the application using the drop down list and text entry boxes 1504, 1506, 1508, and 1510. Activation of the save & next button 1512 saves the current asset to the credit application and proceeds to the next credit application entry screen. Activation of the save & done button 1514 saves the current asset in the application and returns to the welcome screen 900. Activation of the save & new button 1516 saves the current asset in the application and clears the drop down list and text entry boxes 1504, 1506, 1508, and 1510. Activation of the skip button 1518 proceeds to the next credit application entry screen without saving the current data. Activation of the reset button 1520 clears the drop down list and text entry boxes 1504, 1506, 1508, and 1510.

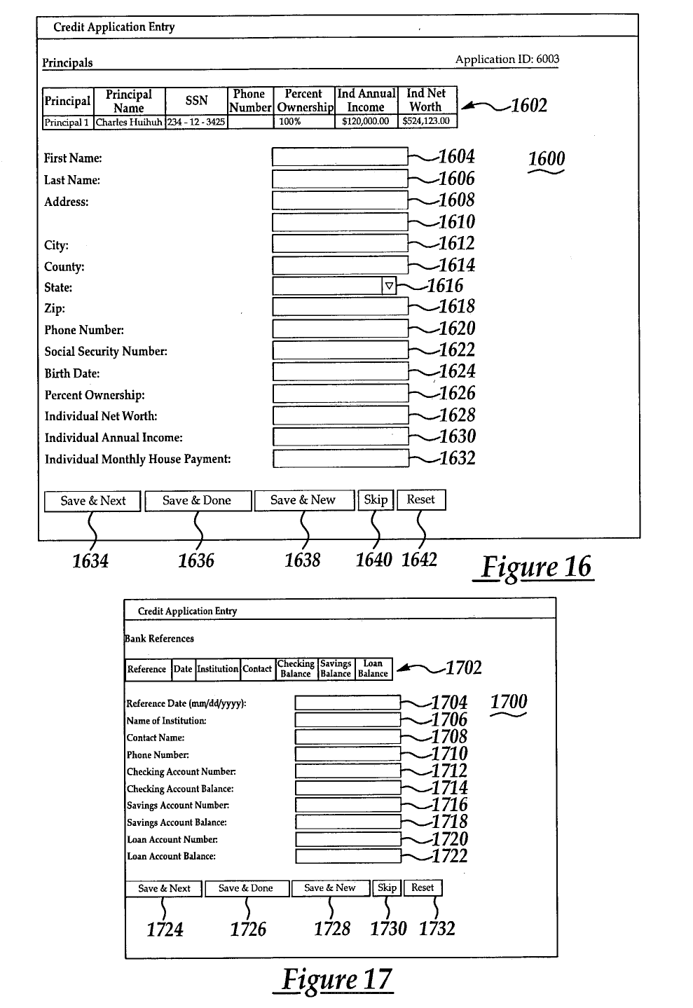

With reference to FIG. 16, a third credit application entry screen 1600 is illustrated. The third credit application entry screen 1600 allows the user 214 to enter information relating to principals, such as, owners, of the customer. The third credit application entry screen 1600 includes a list 1602 which includes information related to the principals already associated with the customer. The third credit application entry screen 1600 also includes a first name text entry box 1604, a last name text entry box 1606, at least one address box 1608, 1610, a city text entry box 1612, a county text entry box 1614, a state drop down list 1616, a zip code text entry box 1618, a phone number text entry box 1620, a social security number text entry box 1622, a birthdate text entry box 1624, a percent ownership text entry box 1626, an individual net worth text entry box 1628, an individual annual income text entry box 1630, and an individual monthly house payment text entry box 1632. The third text credit application entry screen 1600 also includes a save & next button 1634, a save & done button 1636, a save & new button 1638, a skip button 1640, and a reset button 1642. The user 214 is able to enter information related to a principal associated with the customer in the text entry boxes and drop down list 1604, 1606, 1608, 1610, 1612, 1614, 1616, 1618, 1620, 1622, 1624, 1626, 1628, 1630, and 1632. Activation of the save & next button adds an entered principal to the principal list 1602 and proceeds to the next credit application entry screen. Activation of the save & done button 1636 saves a principal to the credit application and returns to the welcome screen 900. Activation of the save & new button 1638 saves an entered principal to the credit application and clears the third application entry screen 1600. Activation of the skip 1640 proceeds to the next credit application entry screen without saving any entered data. Activation of the reset button 1642 clears the third application entry screen 1600.

With reference to FIG. 17, a fourth credit application entry screen 1700 is illustrated. The fourth credit application entry screen 1700 allows the user 214 to enter bank references for a customer. The fourth credit application entry screen 1700 includes a list 1702 of bank references associated with the customer. The fourth credit application entry screen 1700 also includes a reference date text entry box 1704, a name of institution text entry box 1706, a contact name text entry box 1708, a phone number text entry box 1710, a checking account number text entry box 1712, a checking account balance text entry box 1714, a savings account number text entry box 1716, a savings account balance text entry box 1718, a loan account number text entry box 1720, and a loan account balance text entry box 1722. The user 214 may enter data regarding a bank account number or a loan account within the text entry boxes 1704 through 1722. The fourth credit application entry screen 1700 also includes a save & next button 1724, a save & done button 1726, a save & new button 1728, a skip button 1730, and a reset button 1732. Activation of the save & next button 1724 saves the entered bank reference information with the application and advances to the next credit application entry screen. Activation of the save & done button 1726 saves the account information with the credit application and returns to the welcome screen 900. Activation of the save & new button 1728 saves the entered information with the credit application and clears the fourth credit application entry screen 1700. Activation of the skip 1730 advances to the next credit application entry screen without saving any entered data. Activation of the reset button 1732 clears the text entry boxes 1704 through 1722.

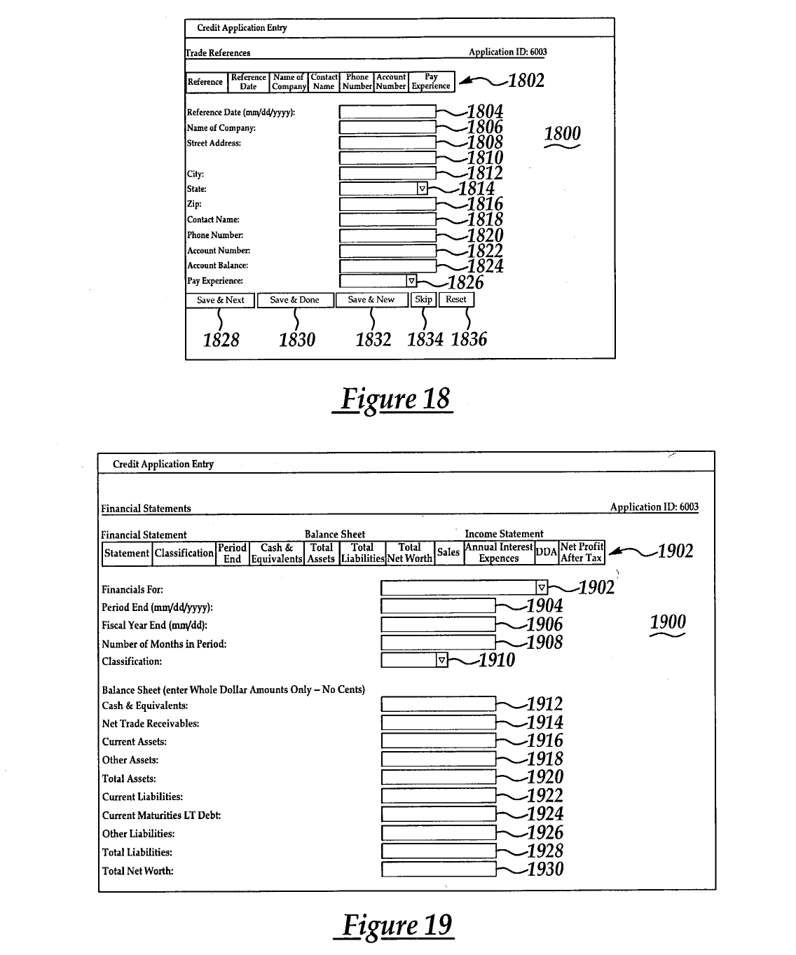

With reference to FIG. 18, a fifth credit application entry screen 1800 is illustrated. The fifth credit application entry screen 1800 allows the user 214 to associate credit or trade references, i.e., other parties with which the customer has had financial dealings, with the credit application. The fifth credit application entry screen 1800 includes a list of trade references 1802 associated with the current credit application. The fifth credit application entry screen 1800 also includes a reference date text entry box 1804, a name of company text entry box 1806, a plurality of street address text entry boxes 1808, 1810, a city text entry box 1812, a state drop down list 1814, a zip code text entry box 1816, a contact name text entry box 1818, a phone number text entry box 1820, an account number text entry box 1822, an account balance text entry box 1824, and a pay experience drop down list 1826. The text entry boxes and drop down lists 1804 1826 allow the user 214 to enter information about trade references that are to be associated with the credit application. The fifth credit application entry screen 1800 also includes a save & next button 1828, a save & done button 1830, a save & new button 1832, a skip button 1834, and a reset button 1836. Activation of the save & next button 1828 saves entered information about a trade reference with the credit application and advances to the next credit application entry screen. Activation of the save & done button 1830 saves entered information about a trade reference with the credit application and returns to the welcome screen 900. Activation of the save & new button 1832 saves information about a trade reference entered into the text entry boxes and drop down list 1804-1826 with the credit application and clears the fifth credit application entry screen 1800. Activation of the skip button 1834 advances to the next credit application entry screen without saving any entered data. Activation of the reset button 1836 clears the text entry boxes and drop down lists 1804-1826.

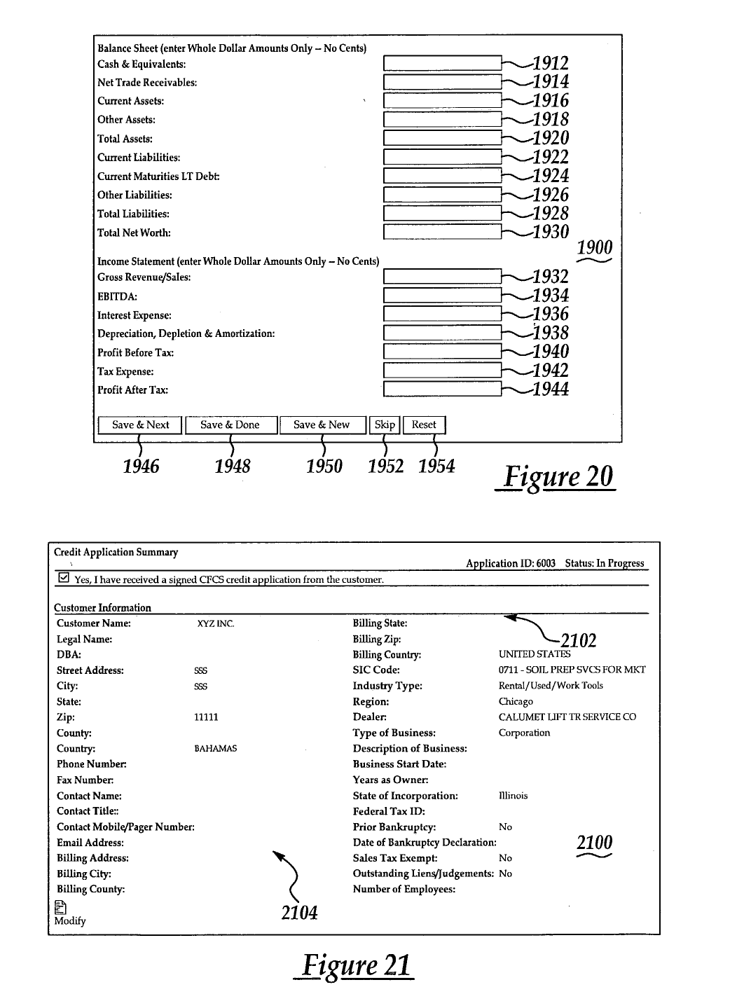

With reference to FIGS. 19 and 20, a sixth credit application entry screen 1900 is illustrated. The sixth credit application entry screen 1900 allows the user 214 to enter information regarding financial statements, e.g., bank statements, to be associated with the credit application. The sixth credit application entry screen 1900 includes a list 1902 of financial statements already associated with the credit application. The sixth credit application entry screen 1900 also includes a financials for drop down list 1902, a text entry box 1904, a fiscal year end text entry box 1906, a number of months in period text entry box 1908, a classification drop down list 1910, a cash and equivalents text entry box 1912, a net trade receivables text entry box 1914, a current assets text entry box 1916, an other assets text entry box 1918, a total assets text entry box 1920, a current liabilities text entry box 1922, a current maturities long term (LT) debt text entry box 1924, an other liabilities text entry box 1926, a total liabilities text entry box 1928, a total net worth text entry box 1930, a gross revenue/sales text entry box 1932, an EBITDA (earning before interest, taxes, depreciation and amortization) text entry box 1934, an interest expense text entry box 1936, a depreciation, depletion and amortization text entry box 1938, a profit before tax text entry box 1940, a tax expense text entry box 1942, and a profit after tax text entry box 1944. The user 214 may enter information regarding the financial statements within the text entry boxes and drop down lists 1902-1944. The sixth credit application entry screen 1900 also includes a save & next button 1946, a save & done button 1948, a save & new button 1950, a skip button 1952, and a reset button 1954. Activation of the save & next button 1946 saves any information about a financial statement with the credit application and advances to the next credit application entry screen. Activation of the save & done button 1948 saves any information regarding a financial statement entered into the text entry boxes and drop down lists 1902-944 with the credit application and returns to the welcome screen 900. Activation of the save & new button 1950 saves any information regarding the financial statement entered into the text entry boxes and drop down lists 1902-1944 with the credit application and clears the sixth credit application entry screen 1900. Activation of the skip button 1952 advances to the next credit application entry screen without saving any entered data. Activation of the reset button 1954 clears the sixth credit application entry screen 1900.

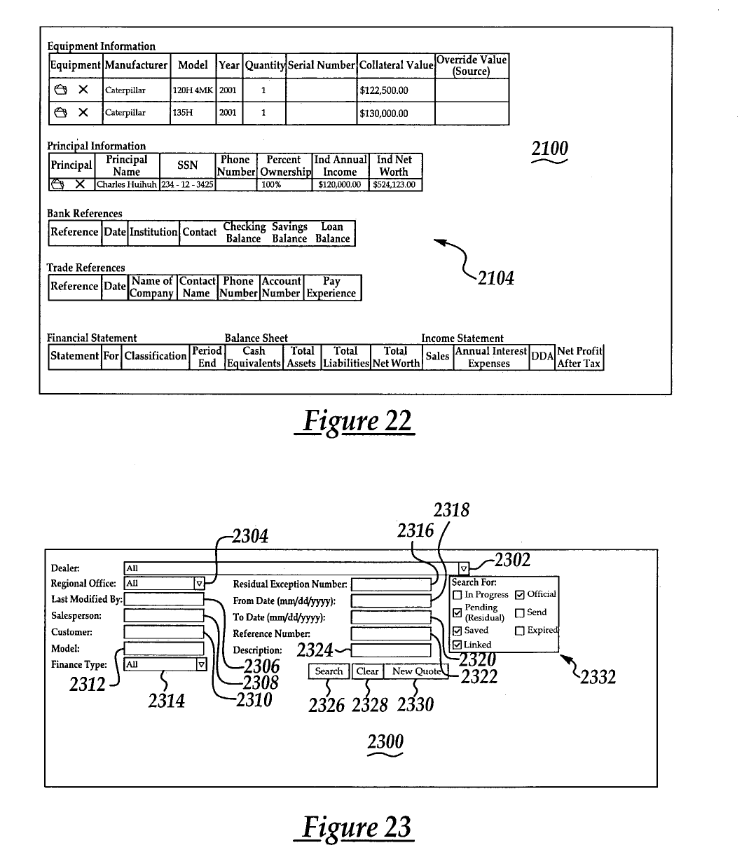

With reference to FIGS. 21 and 22, first and second portions of a credit application summary screen 2100 are illustrated. The credit application summary screen 2100 includes a check box 2102 which is used to indicate whether a signed credit application has been received from the customer and a summary 2104 of the information entered on the credit application.

As discussed above, the credit application then may be submitted for a decision. In one embodiment, the automated computer based system 200 automatically determines whether or not a credit application has been approved based on a set of pre-determined rules.

With reference to FIGS. 25 to 53, the quoting module 222 is accessed and manipulated using a plurality of graphical user interface screens. With reference to FIG. 23, a quote search screen 2300 is illustrated. The quote search screen 2300 is used to search for a existing quote. The quote search screen 2300 includes a dealer drop-down list 2302, a regional office drop-down list 2304, a last modified by text entry box 2306, a salesperson text entry box 2308, a customer text entry box 2310, a model text entry box 2312, a finance type drop-down list 2314, a residual exception number text entry box 2316, a firm date text entry box 2318, a to date text entry box 2320, a reference number text entry box 2322, and a description text entry box 2324. The quote search screen 2300 also includes a search button 2326, a clear button 2328, and a new quote button 2330. Additionally, the quote search screen 2300 includes a plurality of status check boxes 2332. The user 214 may enter information in the drop-down list and text entry boxes 2302-2324 and select the types of quotes to be searched in the check boxes 2332. A search is conducted by activation of the search button 2326. Activation of the clear button 2328 clears the quote search screen 2300. Activation of the new quote button 2330 begins a new quote.

In one embodiment, the user 214 may request an exception to a given residual value or request a lower payment (which would raise the residual value). In response to receiving the request for the residual exception, the automated computer based system 200 automatically determines to approve or deny the residual exception.

Activation of the search button 2326 displays a list (not shown) of the quotes which meet the entered criteria. Selection of one of the quotes allows the user 214 to edit the selected quote.

The following description describes the screens used in the creation of a new quote; however, similar screens are used to modify an existing quote.

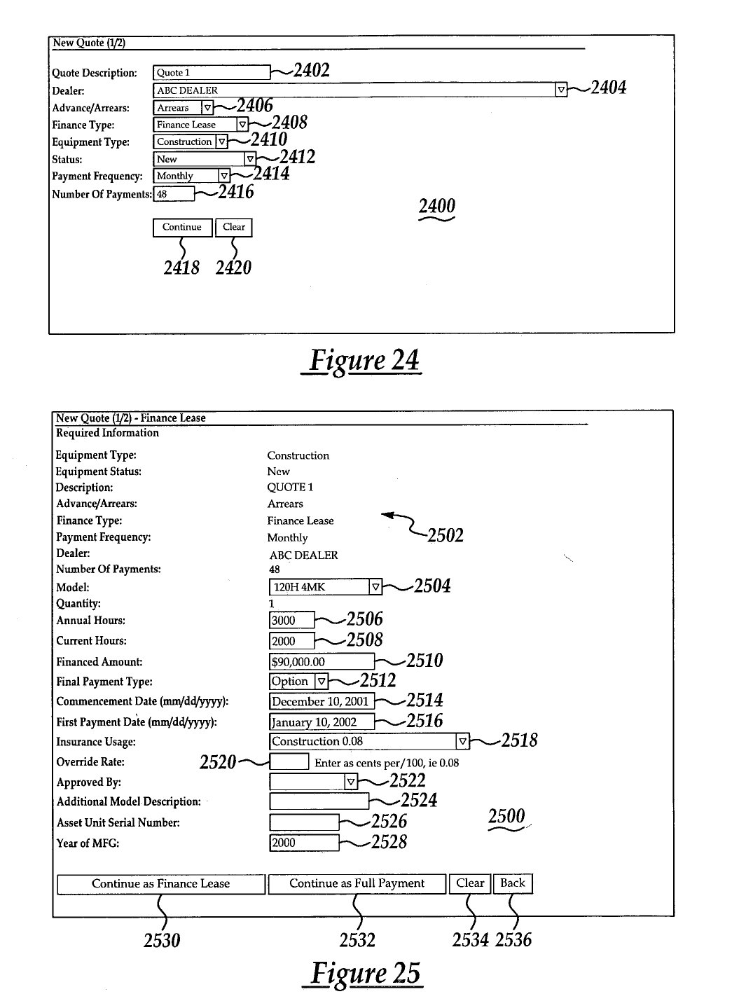

With reference to FIG. 24, a first new quote screen 2400 is displayed. The first new quote screen 2400 includes a quote description text entry box 2402, a dealer drop-down list 2404, an advance/arrears drop-down list 2406, a finance type drop-down list 2408, an equipment drop-down list 2410, a status drop-down list 2412, a payment frequency drop-down list 2414, and a number of payments text entry box 2416. The user 214 enters the information in the text entry boxes and drop-down list 2402-2416 which describe the new quote. The first new quote entry screen 2400 includes a continue button 2418 and a clear button 2420. Activation of the continue button 2418 proceeds to the next screen. Activation of the clear button 2420 clears the first new quote entry screen 2400.

With reference to FIG. 25, a second new quote entry screen 2500 is illustrated. The second new quote entry screen 2500 includes an information section 2502. A model number drop-down list 2504, an annual hours text entry box 2506, a current hours text entry box 2508, a financed amount text entry box 2510, a final payment type drop down list 2512, a commencement date text entry box 2514, a first payment text entry box 2516, an insurance usage drop-down list 2518, an override rate text entry box 2520, an improved by drop-down list 2522, an additional model description text entry box 2524, an asset unit serial number text entry box 2526, and a year of manufacture text entry box 2528. The second new quote entry screen 2500 also includes a continue as finance lease button 2530, a continue as full payout button 2532, a clear button 2534, and a back button 2536. The user 214 enters additional information regarding the quote and the drop-down list and text entry boxes 2504 through 2528. Activation of the continue as finance lease button 2530 or the continue as full payout button 2532 continues to the next screen depending on which button is pressed. Activation of the clear button 2534 clears the second new quote entry screen 2500. Activation of the back button 2536 returns the user 214 to the first quote entry screen 2400.

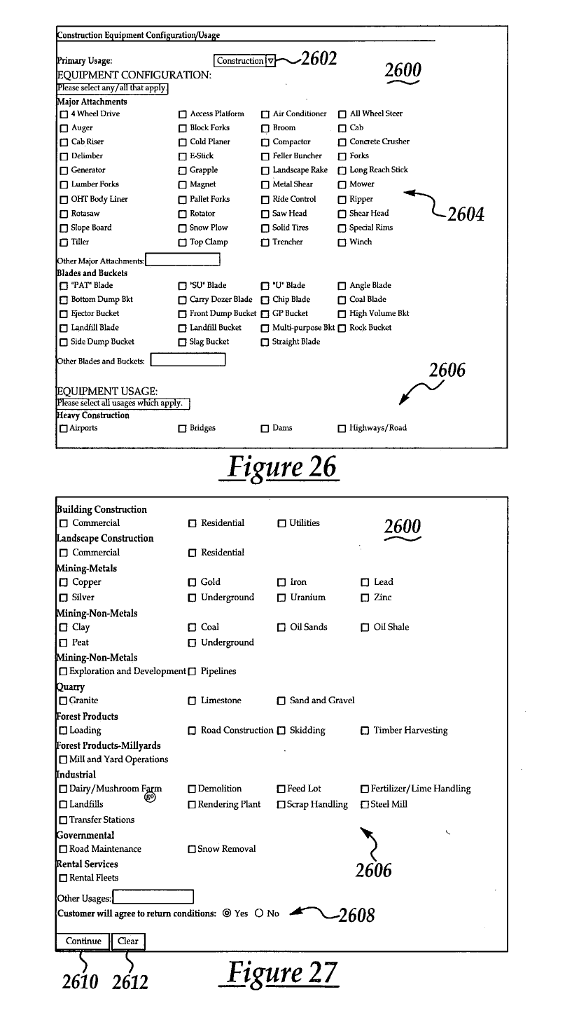

With reference to FIGS. 26 and 27, first and second portions of a construction equipment configuration/usage screen 2600 is shown. The configuration/usage screen 2600 allows the user 214 to select accessories and attachments for the subject item of the quote and to select the primary usage of the equipment. The configuration/usage screen 2600 includes a primary usage drop-down list 2602. In the illustrated embodiment, the configuration/usage screen 2600 also includes an equipment configuration section 2604 which includes a plurality of check boxes for adding attachments/blades and/or buckets to the selected equipment. An equipment usage section 2606 allows more detailed information regarding the use of the equipment to be selected. The configuration/usage screen 2600 also includes a pair of yes/no checkboxes which allows the user to indicate whether or not the customer has agreed to return conditions. The configuration/usage screen 2600 also includes a continue button 2610 and a clear button 2612. Activation of the continue button 2610 continues to the next screen. Activation of the clear button 2612 clears the configuration/usage screen 2600.

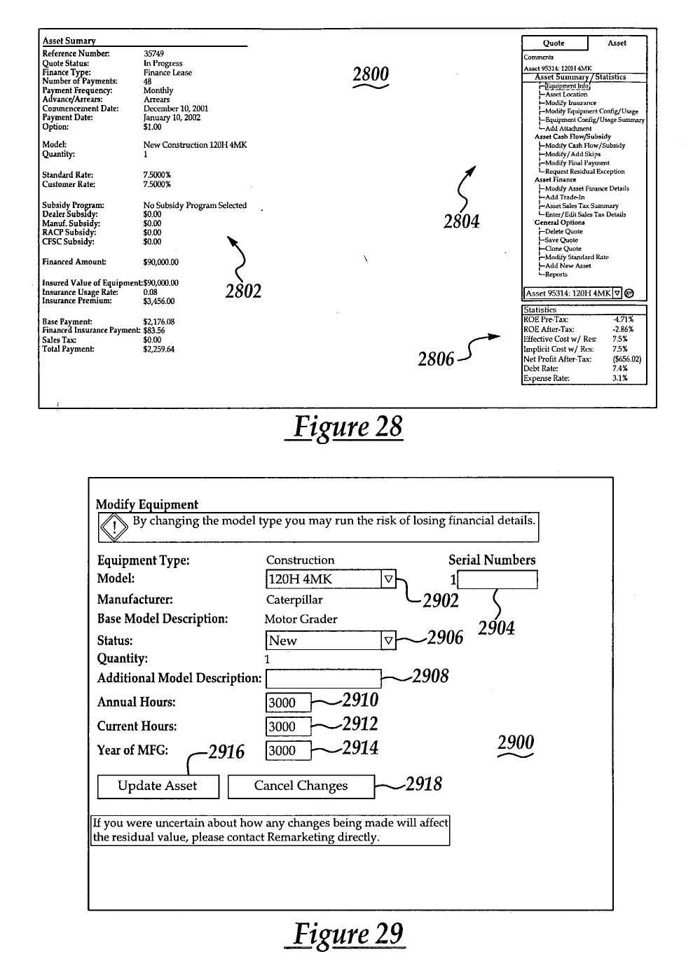

With reference to FIG. 28, an asset summary screen 2800 is illustrated. The asset summary screen 2800 includes an information section 2802 which includes information regarding the current quote. The asset summary screen 2800 also includes a navigational area 2804 which includes a number of links to different screens within the quoting module. Selection of a link display to the corresponding screen. The asset summary screen 2800 also includes a statistic section 2806 which includes financial information regarding the current quote.

It should be noted that some of the preceding and the following screens allow the user 214 to specify details about the current quote. However, the same or similar screens may be used to modify portions or information related to the quote after the transaction start date (as described above).

With reference to FIG. 29, a modify equipment screen 2900 is illustrated. The modify equipment screen 2900 includes an equipment type drop-down list 2902, a serial number text entry box 2904, a status drop-down list 2906, an additional model description text entry box 2908, an annual hours text entry box 2910, a current hours text entry box 2912, a year of manufacture text entry box 2914. The user 214 may enter modified information regarding the equipment which is the subject of the quote in the drop-down boxes and text entry boxes 2902 through 2914. The modify equipment screen 2900 also includes an update asset 2916 button and a cancel changes button 2918. Activation of the update asset button 2916 updates the quote using the information entered on the modify equipment screen 2900. Activation of the cancel changes button 2918 clears the modify equipment screen 2900.

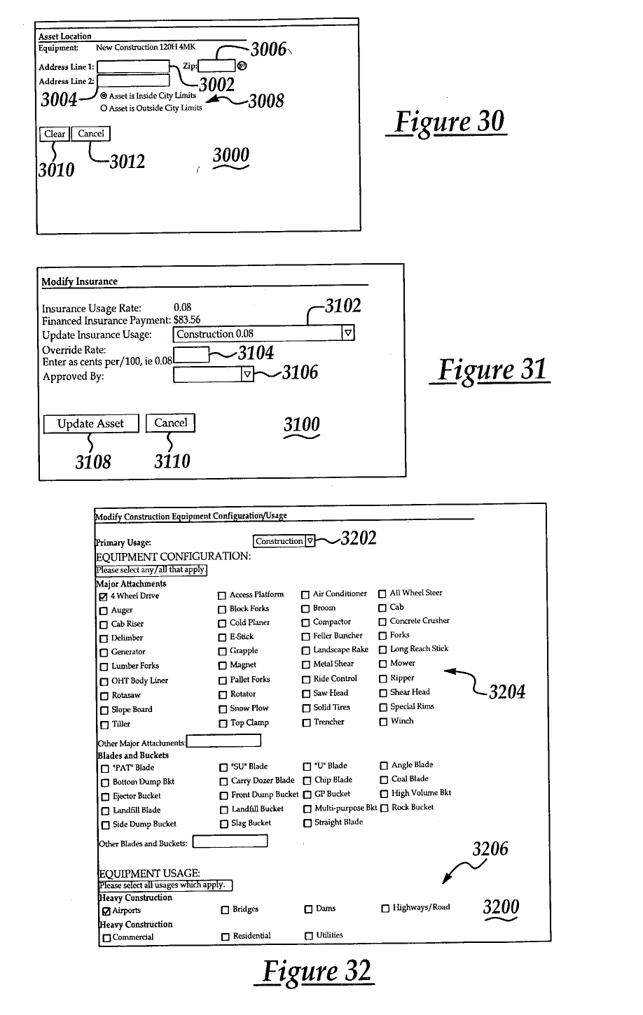

With reference to FIG. 30, an asset location screen 3000 screen is illustrated. The asset location screen 3000 allows the user 214 to set or update the location of the asset. The asset location screen 3000 includes an address line text entry box 3002, a second address text entry box 3004, a zip code text entry box 3006, and a plurality of check boxes 3008. The plurality of checkboxes 3008 allow the user 214 to set whether the equipment is to be inside or outside the city limits. The asset location screen 3000 also includes a clear button 3010 and a cancel button 3012.

With reference to FIG. 31, a modify insurance screen 3100 is illustrated. The modify insurance screen 3100 allows the user 214 to change the insurance terms of the quote. The modify insurance screen 3100 includes an update insurance usage drop-down list 3102 and an override text entry box 3104 and an improved by drop-down list 3106. The modify insurance screen 3100 also includes an update asset button 3108 and a cancel button 3110. Activation of the update asset button 3108 updates the quote using the information entered on the modify insurance screen 3100.

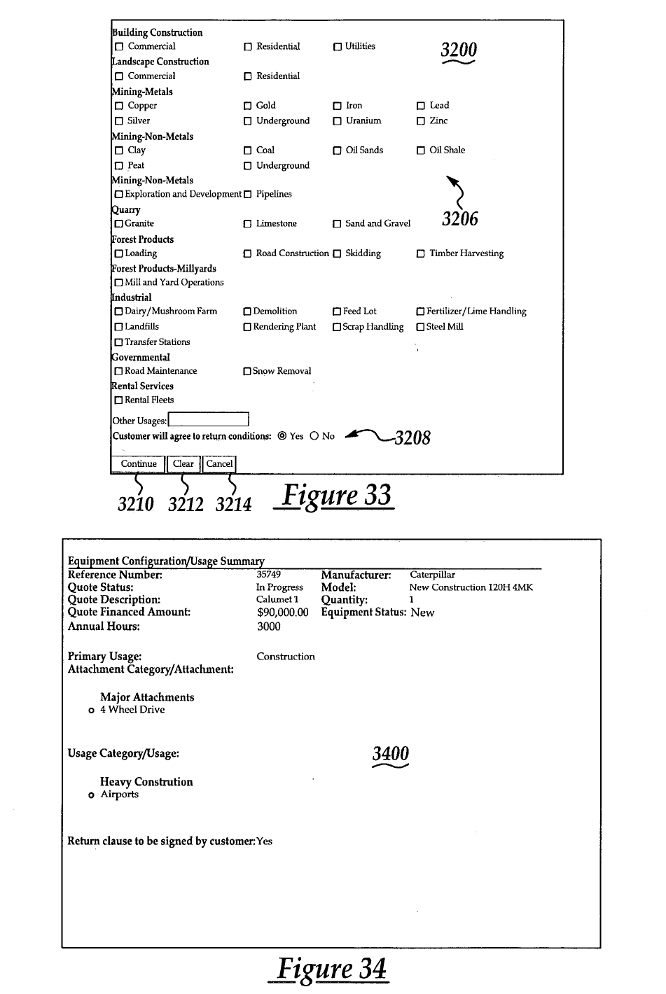

With reference to FIGS. 32 and 33, first and second portions of a modify configuration/usage screen 3200 is illustrated. The modify configuration/usage screen 3200 allows the user 214 to modify equipment configuration and usage information in the quote. In the illustrated embodiment, the modify configuration/usage screen 3200 includes a primary usage drop-down list 3202, an equipment configuration section 3204 and an equipment usage section 3206.

The modify configuration/usage screen 3200 also includes a pair of yes/no checkboxes 3208, an update button 3210, a clear button 3212 and a cancel button 3214. Operation of the modify configure/usage screen 3200 is similar to the configuration/usage screen 2600.

With reference to FIG. 34, an equipment configuration/usage summary screen 3400 is illustrated. The summary screen 3400 includes a summary information of the information entered or modified in the previous screens.

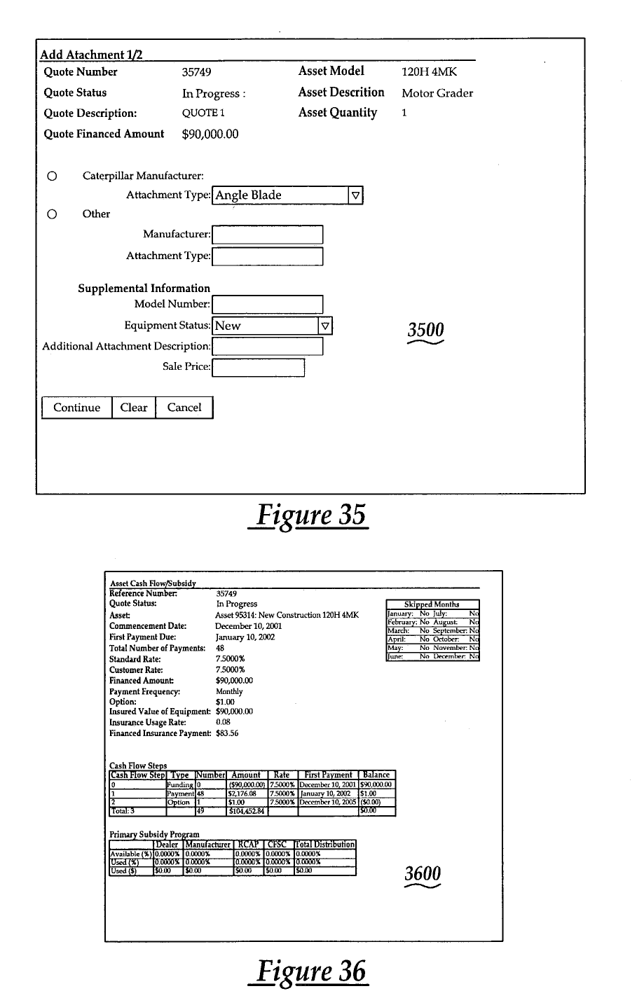

With reference to FIG. 35, an add attachment screen 3500 is illustrated. The add attachment screen 3500 allows the user 214 to add an attachment to the equipment which is the subject of the quote.

With reference to FIG. 36, an asset cash flow/subsidy summary screen 3600 is illustrated. Based on entered information and default information, the asset cash flow/subsidy screen 3600 includes information related to the quote, the proposed financing and cash flow.

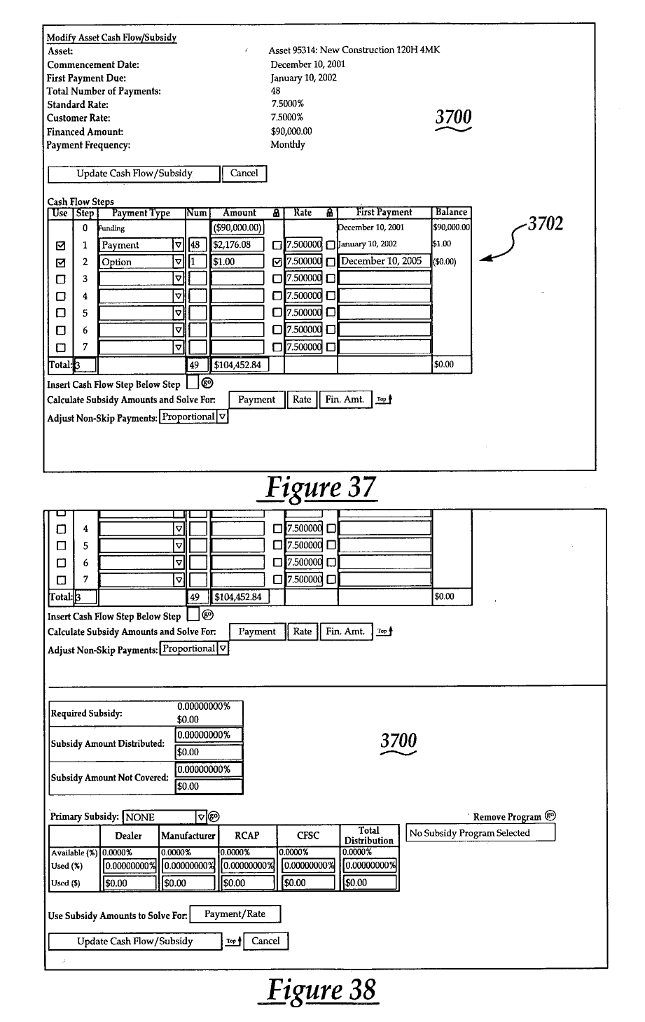

With reference to FIGS. 37 and 38, first and second portions of a modify asset cash flow/subsidy screen 3700 are illustrated. The modify asset cash flow/subsidy screen 3700 includes a cash flow step section 3702 which allows the user 214 to define cash flow steps and define different parameters for each cash flow step, for example, the payment type, the number of payments, the amount, the rate, and the date of first payment.

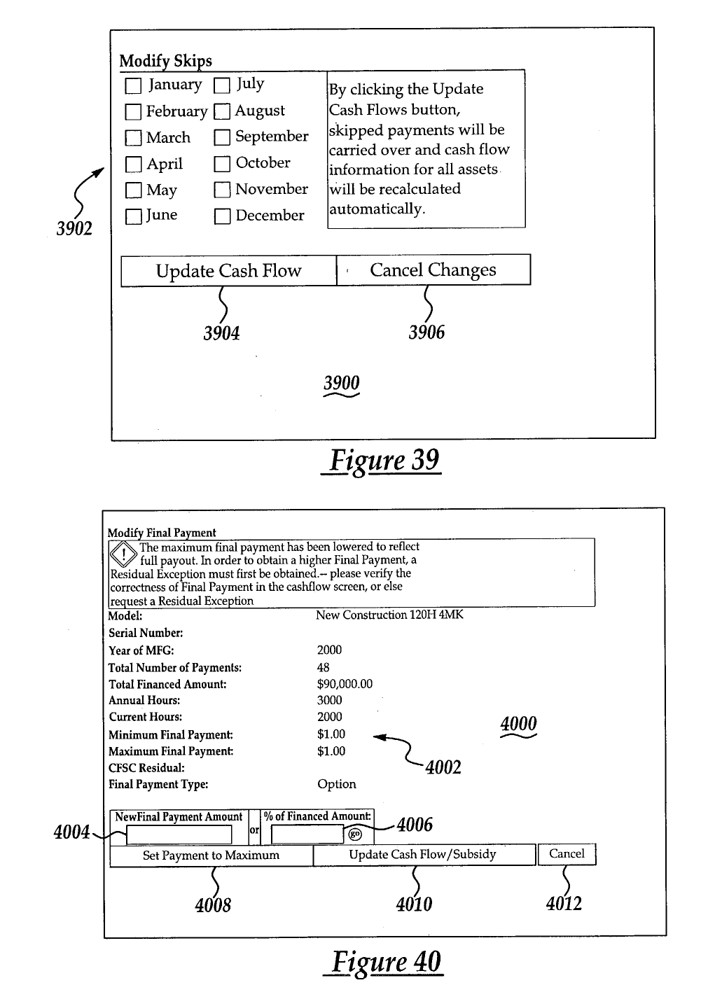

With reference to FIG. 39, a modify skip screen 3900 is illustrated. The modify skip screen 3900 allows the user to indicate months in which there will be no payment. In the illustrated embodiment, the modify skip screen 3900 includes a check button 3902 for each month of the year. The modify skip screen 3900 also includes an update cash flow button 3904 and a cancel change button 3906.

With reference to FIG. 40, a modify final payment screen 4000 is illustrated. The modify final payment screen 4000 includes an information section 4002 which summarizes information associated with the quote. The modify final payment screen 4000 also includes a new final payment amount text entry box 4004 and a percent of financed amount text entry box 4006. The user 214 may enter a new final payment amount or a percentage of financed amount in the corresponding text entry box 4004, 4006. The modify final payment screen 4000 also includes a set payment to maximum button 4008, an update cash flow/subsidy button 4010, and a cancel button 4012.

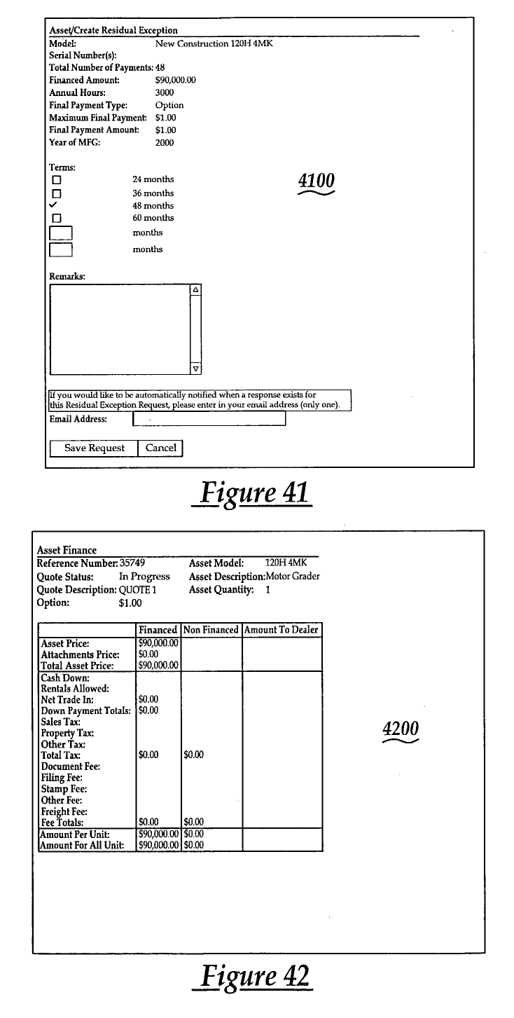

With reference to FIG. 41, an asset/create residual exception screen 4100 is illustrated. The asset/create residual exception screen 4100 allows the user 214 to request an exception to the default maximum residual.

With reference to FIG. 42, an asset finance summary screen 4200 is illustrated. The asset finance screen 4200 includes a summary of financed and non-financed amounts associated with the current quote.

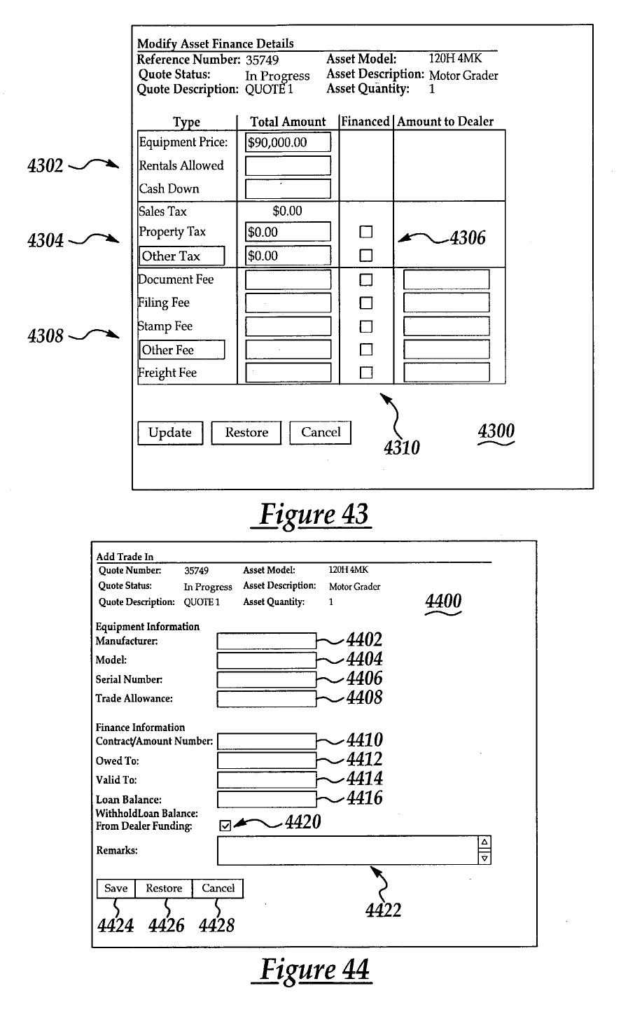

With reference to FIG. 43, a modify asset finance details screen 4300 is illustrated. The modify asset finance detail screen 4300 allows the user 214 to modify information related to the cost of the equipment, taxes associated with the equipment, and other fees. The modify asset finance detail screen 4300 includes a plurality of text entry boxes 4302 which allows the user to modify or set the equipment price, a cost associated with rentals, and an amount of cash down. The modify asset finance detail screen 4300 also includes a plurality of text entry boxes 4304 and associated checkboxes 4306 which allow the user 214 to set tax amounts as well as to indicate whether or not the tax amounts are included in the financial transaction. The modify asset finance detail screen 4300 also includes a plurality of text entry boxes 4308 and checkboxes 4310 which allow the user to set costs associated with various fees and to indicate whether or not the fees are included in the financial transaction.

With reference to FIG. 44, an add trade-in screen 4400 is illustrated. The add trade-in screen 4400 allows the user to add a trade-in to the quote. The add trade-in screen 4400 includes a text and equipment information manufacturer text entry box 4402, a model text entry box 4404, a serial number text entry box 4406 and a trade-in allowance text entry box 4408. The add trade-in screen 4400 also includes a finance information contract/account number text entry box 4410, an owed to text entry box 4412, a valid to text entry box 4414, and a loan balance text entry box 4416. Additionally, the add trade-in screen 4400 includes a withhold loan balance from dealer finding the checkbox 4418 and a remarks section 4420. The text entry boxes, the checkbox and the remarks section 4402 4422 allow the user to define an asset to be traded in. The add trade-in screen 4400 also includes a save button 4424, a restore button 4426, and a cancel button 4428.

As discussed above, the automated computer based system 200 and method 300, 400, 500 are partially implemented within computer program applications. The automated computer based system 200 and method 300, 400, 500 may be accessed by remote computers located at dealers or sale outlets and are used by employees of the dealers or sale outlets.

In an alternate embodiment, portions of the automated computer based system 200 and method 300, 400, 500 may also be accessed customer through kiosks located at the dealers or sale outlets.

An a second alternate embodiment, portions of the automated computer based system 200 and method 300, 400, 500 may also be accessed through a dealer website, i.e., a website under the name of the dealer. The dealer's website may include a front-end through which a customer may access the system 200.

For example, the customer may be permitted to obtain a quote and place an order via the kiosk or dealer website. In one embodiment, the automated computer based system 200 and method 300, 400, 500 contains list prices for the available equipment (new or used) and allows the customer to place an order for equipment at the list price. In another embodiment, the automated computer based system 200 and method 300, 400, 500 allow the user to enter a code which gives access to special pricing. For example, the code could give access to sale prices, special customer prices, subsidies, and/or a previously negotiated price.

Through the kiosk or the dealer's storefront website on the internet, the customer may be allowed to rent equipment, configure equipment, apply for credit, obtain approval for equipment rental or purchase, obtain information about their account and/or review the equipment that is available from the dealer or factory.

Industrial Applicability

With specific reference to FIG. 1, the present invention provides an automated computer based system 200, method 300, 400, 500 and computer program product 600, 700, 800 for use in a financial transaction. The automated computer based system 200, method 300, 400, 500 and computer program product 600, 700, 800, in practice, are generally part of a sale or lease transaction for products or services, including equipment, assets or other items, e.g., construction equipment.

In one embodiment, the customer (purchaser or lessee) interacts with the automated computer based system 200 via a graphical user interface 214. For example, a customer may access the system 200 through a dealer's website on the internet. Using the system 200, the customer may configure a piece of equipment according the their needs. Based on the customer's configuration and other information input by the customer, the system 200 develops a price for the equipment. As discussed above, the customer may also apply for financing through the system 200. Additionally, if the customer's credit application is not approved, the system 200 may provide other options, for example, a list of available used or rental equipment. If the customer's credit application is approved, the system 200 may locate and secure the equipment for the customer.

In another embodiment, the customer interacts with an employee (sales agent) of a dealer, a financial company or the manufacturer who interacts with the automated computer based system 200 via the graphical user interface.

As described above, there are generally three steps to the transaction: the quoting process, the credit process and the document preparation process. In the quoting process, the type and number of equipment, the type of contract, and the maximum size payment desired by the client are determined. The automated computer based system 200 performs a credit check on the customer to determine whether or not to extend the desired credit to the customer. Past customer conduct with respect to payment history to the financial company may also be considered. After the credit process, the transaction documents needs to be prepared.

The document module 224 generates a list and/or the required documents using information gathered during the quoting process and the credit process. Additional information regarding the customer may be retrieved from other systems, e.g., the customer's past credit history with the finance company.

After the beginning date of the transaction, conditions, e.g., reduced customer cash flow, may change which may require that the terms of the transaction be modified. The automated computer based system 200 allows access to both the original quote and credit application information. Information within the original quote and/or credit application may be modified and revised transaction documents may be generated.

Other aspect and features of the present invention can be obtained from a study of the drawings, the disclosure, and the appended claims.

What is claimed is:

1. A method for use in a financial transaction, comprising:
establishing a quote for the transaction, the quote including at least one item included in the transaction;
establishing a set of terms for the transaction, the terms including an amount to be financed;
automatically providing a set of financial documents for the transaction as a function of the quote and the set of transaction terms;
establishing at least one changed parameter after a start date of the transaction;
modifying the terms of the transaction in response to the at least one changed parameter; and,
automatically providing a set of revised financial documents for the transaction as a function of the modified terms of the transaction.

2. A method, as set forth in claim 1, wherein the step of establishing a set of terms for the transaction includes the steps of:
filling out an online credit application;
retrieving a credit report as a function of the credit application; and,
establishing the amount to be financed as a function of the credit report.

3. A method, as set forth in claim 1, wherein the step of modifying the terms of the transaction include the step of changing a residual value.

4. A method, as set forth in claim 1, wherein the step of modifying the terms of the transaction include the step of changing at least one payment of the transaction.

5. A method, as set forth in claim 1, including the step of automatically determining a tax value related to the transaction as a function of a set of contract characteristics and customer location information.

6. A method, as set forth in claim 1, including the step of automatically determining a price associated with a warranty associated with the item.

7. A method, as set forth in claim 1, including the step of providing online access to account information related to the transaction.

8. A method, as set forth in claim 1, including the step of providing online access to account information related to the transaction to a customer.

9. A method, as set forth in claim 1, wherein the account information includes at least one of account balance, principal balance, interest paid, last paid date, next due date, mail date, invoice number of last invoice, and payoff balance.

10. A method, as set forth in claim 1, wherein the step of establishing a quote includes the step of establishing a subsidy for the transaction.

11. A computer based system for use in a financial transaction, comprising:
a finance computer application located at a first location; and,
a second computer application coupled to the finance computer application and being located at a second location, the second computer application being adapted to provide access for a user to the finance computer application;
wherein the finance computer application is adapted to establish a quote and to establish a set of terms for the transaction as a function of the quote, the quote includes at least one item included in the transaction and the set of terms includes an amount to be financed, to automatically provide a set of financial documents for the transaction as a function of the quote and the set of transaction terms, and to establish at least one changed parameter after a start date of the transaction, modify the terms of the transaction in response to the at least one changed parameter, and automatically provide a set of revised financial documents for the transaction as a function of the modified terms of the transaction.

12. A computer based system, as set forth in claim 11, wherein the second computer application is adapted to allow the user to fill out a credit application and is adapted to retrieve a credit report as a function of the credit application and establish the amount to be financed as a function of the credit report.

13. A computer based system, as set forth in claim 11, wherein the finance computer application is adapted to change a residual value of the transaction.

14. A computer based system, as set forth in claim 11, wherein the finance computer application is adapted to change at least one payment of the transaction.

15. A computer based system, as set forth in claim 11, wherein the finance computer application is adapted to determine a tax value related to the transaction as a function of a set of contract characteristics and customer location information.

16. A computer based system, as set forth in claim 11, wherein the finance computer application is adapted to determine a price associated with a warranty associated with the item.

17. A computer based system, as set forth in claim 11, wherein the finance computer application is adapted to provide online access to account information related to the transaction.

18. A computer based system, as set forth in claim 11, wherein the finance computer application is adapted to provide online access to account information related to the transaction to a customer.

19. A computer based system, as set forth in claim 11, wherein the account information includes at least one of account balance, principal balance, interest paid, last paid date, next due date, mail date, invoice number of last invoice, and payoff balance.
A computer based system, as set forth in claim 11, wherein the
second computer application allows the user to establish a credit application.

20. A computer based method for use in a financial transaction, comprising:
establishing a quote for the transaction, the quote including at least one item included in the transaction;
establishing a set of terms for the transaction, including an amount to be financed;
automatically providing a set of financial documents for the transaction as a function of the item and the set of transaction terms; and,
linking the transaction with a production process.

21. A computer based method, as set forth in claim 20, linking the transaction with a production process includes the step of establishing a delivery date for the at least one item.

22. A computer based method, as set forth in claim 20, wherein the step of linking the transaction with a production process includes the step of identifying a dealer through which the at least one item will be provided.

23. A computer based method, as set forth in claim 20, wherein the step of linking the transaction with a production process includes the step of a delivering an order to one of a manufacturing plant or a warehouse for the at least one item.

24. A computer based method, as set forth in claim 20, wherein the step of linking the transaction with a production process includes the step of sending a request for material to a supplier.

25. A computer based method, as set forth in claim 20, wherein the step of linking the transaction with a production process includes the step of scheduling transportation for equipment.

26. A computer based system for use in a financial transaction, comprising:
a finance computer application located at a first location; and,
a second computer application coupled to the finance computer application and being located at a second location, the second computer application being adapted to provide access for a user to the finance computer application and to allow the user to establish a credit application;
wherein the finance computer application is adapted to establish a quote for the transaction and to establish a set of terms for the transaction as a function of the credit application and the quote, the quote including at least one item included in the transaction, the set of terms including an amount to be financed, to automatically provide a set of financial documents for the transaction as a function of the quote and the set of transaction terms, and to link the transaction with a production process.

27. A computer based system, as set forth in claim 26, wherein the finance computer application is adapted to establish a delivery date for the at least one item.

28. A computer based system, as set forth in claim 26, wherein the finance computer application is adapted to identify a dealer through which the at least one item will be provided.

29. A computer based system, as set forth in claim 26, wherein the finance computer application is adapted to place an order for the at least one item with one of a manufacturing plant or a warehouse.

30. A computer based system, as set forth in claim 26, wherein the finance computer application is adapted to send a request for material to a supplier.

31. A computer based system, as set forth in claim 26, wherein the finance computer application is adapted to schedule transportation for equipment

32. A method for providing financing for a transaction, comprising:
establishing a quote for the transaction, the quote including at least one item included in the transaction;
completing an online credit application;
determining an amount to be financed as a function of the quote and the credit application; and,
establishing a set of terms for the transaction as a function of the quote, the credit application, and the amount, the set of terms includes a tax value related to the transaction as a function of a set of contract characteristics and customer location information.

33. A method, as set forth in claim 32, wherein the establishing a quote includes the step of establishing a subsidy for the transaction.

34. A method for providing financing for a transaction, comprising:
establishing a quote for the transaction, the quote including at least one item included in the transaction;
completing an online credit application;
determining an amount to be financed as a function of the quote and the credit application; and,
establishing a set of terms for the transaction as a function of the quote, the credit application, and the amount, the set of terms includes a price associated with a warranty associated with the item.

35. A method, as set forth in claim 34, wherein the establishing a quote includes the step of establishing a subsidy for the transaction.

36. A method for providing financing for a transaction, comprising:
establishing a quote for the transaction, the quote including at least one item included in the transaction;
completing an online credit application through a dealer;
determining an amount to be financed as a function of the quote and the credit application; and,
establishing a set of terms for the transaction as a function of the quote, the credit application, and the amount.

37. A method, as set forth in claim 36, wherein the step of establishing a quote for the transaction is performed online through the dealer and the step of providing the credit application is includes the step of providing the credit application through at least one of a kiosk at the dealer and through a dealer website.

38. A method, as set forth in claim 36, including the step of providing a list of available used items if the online credit application is denied.

39. A method, as set forth in claim 36, including the step of providing a list of available rental equipment if the online credit application is denied.

40. A method, as set forth in claim 36, wherein the step of establishing a quote for the transaction include the step of configuring the item.

41. A computer based method for use in a financial transaction, comprising:
establishing a set of terms for the transaction, the terms including an amount to be financed;
automatically providing a set of financial documents for the transaction as a function of the set of transaction terms; and,
verifying receipt of executed documents.

42. A computer based method, as set forth in claim 41, wherein the step of verifying receipt of the executed documents is performed automatically.

43. A computer based method, as set forth in claim 41, including the step of booking the transaction in response to verification of the receipt of the executed documents.

44. A computer based method, as set forth in claim 41, including the step of sending information related to the transaction to an accounts receivable system.

45. A computer based method, as set forth in claim 41, wherein the financial transaction provides financing to a customer for an item provided by a third party, including the step of wherein the transferring funds to the third party for the item.

46. A computer based method, as set forth in claim 45, wherein the step of transferring funds includes the step of automatically generating a check.

47. A computer based method, as set forth in claim 45, wherein the step of transferring funds includes the step of electronically transferring money to the third party.

48. A computer based method, as set forth in claim 45, wherein the financial transaction provides financing to a customer for an item, including the step of automatically generating an invoice for the customer in response to booking the transaction.

49. A computer based system for use in a financial transaction, comprising:
a finance computer application located at a first location; and,
a second computer application coupled to the finance computer application and being located at a second location, the second computer application being adapted to provide access for a user to the finance computer application;
wherein the finance computer application is adapted to establish a set of terms for the transaction, the set of terms includes an amount to be financed, to automatically provide a set of financial documents for the transaction as a function of the set of transaction terms, and to verify receipt of executed documents.

50. A computer based system, as set forth in claim 49, wherein the documents are manually signed and the user manually verifies receipt of the executed documents using the finance computer application.

51. A computer based system, as set forth in claim 49, wherein the documents are electronically executed and the finance computer application automatically verifies receipt of the executed document.

52. A computer based system, as set forth in claim 49, further including an accounts receivable application, the finance computer application adapted to book the transaction in the accounts receivable application in response to verification of the receipt of the executed documents.

53. A computer based system, as set forth in claim 49, wherein the finance computer application sends information related to the transaction to the accounts receivable system.

54. A computer based system, as set forth in claim 52, wherein the transaction provides financing to a customer for an item provided by a third party, the accounts receivable application transferring funds to the third party for the item in response to booking of the transaction.

55. A computer based system, as set forth in claim 54, wherein the accounts receivable application automatically generates a check to the third party for the funds.

56. A computer based system, as set forth in claim 54, wherein the accounts receivable application automatically and electronically transfers money to the third party.

57. A computer based system, as set forth in claim 52, wherein the financial transaction provides financing to a customer for an item, the accounts receivable application automatically generating an invoice for the customer in response to booking the transaction.
